(19) United States
(12) Patent Application Publication
(10) Pub. No.: US 2026/0289089 A1
(43) Pub. Date: Sep. 24, 2026

(54) SYSTEM

(71) Applicant: SoftBank Group Corp., Tokyo (JP)

(72) Inventor: Hirofumi TAKAHASHI, Tokyo (JP)

(73) Assignee: SoftBank Group Corp., Tokyo (JP)

(21) Appl. No.: 19/567,426

(22) Filed: Mar. 16, 2026

(30) Foreign Application Priority Data
Mar. 19, 2025 (JP) 2025-045261

(51) Int. Cl. G06F 40/166; G06F 40/40

(52) U.S. Cl. CPC G06F 40/166; G06F 40/40

(57) ABSTRACT

A system includes a processor that is configured to acquire and analyze attribute information of a subordinate, generate a prompt for instructing a generative artificial intelligence model to generate wording, input the prompt into the generative artificial intelligence model, and generate the wording by using the generative artificial intelligence model, and analyze an emotion of a user and adjust a proposal of the wording based on a result of the analysis.

### CROSS-REFERENCE TO RELATED APPLICATION

This application is based on and claims priority under 35 USC 119 from Japanese Patent Application No. 2025-045261 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for supporting communication between managers and subordinates do not sufficiently adapt the wording of messages to the attributes of the subordinate or to the emotional state of the user who is creating the message. As a result, there is a risk that the subordinate may misunderstand the intention of the manager's instruction or feedback, or may feel unnecessarily stressed or dissatisfied. Furthermore, known systems generally do not monitor ongoing communication for harassment prevention in real time, and do not actively detect inappropriate expressions in exchanges between managers and subordinates. Consequently, problematic expressions may remain unnoticed and uncorrected, leading to potential harassment, deterioration of workplace relationships, and legal or compliance risks. In addition, conventional tools fail to provide specific guidelines that clarify the content of instructions in a manner tailored to the subordinate's understanding, which can lead to ambiguity, misinterpretation of tasks, reduced performance, and lowered motivation.

### SUMMARY

In order to solve the above-described problems, a system according to one aspect of the present invention comprises a processor configured to acquire and analyze attribute information of a subordinate, such as age, position, and other profile data, and to generate a prompt for instructing a generative artificial intelligence model to generate wording. The processor is configured to input the generated prompt into the generative artificial intelligence model and generate wording appropriate to the subordinate by using the generative artificial intelligence model. The processor is further configured to analyze an emotion of a user, such as the manager, for example based on the user's input text or interaction behavior, and to adjust a proposal of the wording based on a result of the emotion analysis, thereby providing wording that is more acceptable and comprehensible to the subordinate while reflecting the emotional state of the user in a controlled manner. In addition, the processor is configured to monitor communication between a manager and the subordinate in order to prevent harassment, and to detect inappropriate expressions in the communication so that such expressions can be corrected or flagged before causing harm. Furthermore, the processor is configured to provide guidelines for clarifying content of an instruction so that the subordinate can appropriately understand the instruction from the manager, thereby reducing ambiguity and supporting effective and safe communication within the organization.

The term “processor” refers to one or more hardware processing units, such as a central processing unit (CPU), a graphics processing unit (GPU), a digital signal processor (DSP), or any combination thereof, that executes instructions of a program to perform the functions described in this specification.

The term “subordinate” refers to an employee, staff member, or other person who receives instructions, guidance, or feedback from a manager or superior in an organizational or work-related context.

The term “attribute information” refers to information indicating characteristics of a subordinate, including, for example, age, position, job role, department, experience, and other profile data relevant to communication.

The term “analyze” refers to processing data by using one or more algorithms, such as rule-based processing, statistical methods, or machine learning techniques, in order to extract features, determine patterns, or derive evaluation results.

The term “generative artificial intelligence model” refers to an artificial intelligence model, such as a neural network-based language model, which generates text or wording in response to an input prompt.

The term “prompt” refers to data, including text, parameters, or structured information, that is provided as input to a generative artificial intelligence model in order to cause the model to generate wording or other output.

The term “wording” refers to one or more sentences, phrases, or expressions generated for use in communication, including instructions, feedback, comments, or explanations directed to a subordinate.

The term “user” refers to a person who operates the system, such as a manager, supervisor, or other person responsible for communicating with a subordinate through the system.

The term “emotion” refers to an emotional state or affective condition of a user, such as stress, anger, calmness, or satisfaction, inferred from user input, behavior, or other detectable signals.

The term “proposal of the wording” refers to a suggestion or recommended version of wording, generated by the system and presented to the user for use in communication with a subordinate.

The term “monitor communication” refers to acquiring and analyzing information related to exchanges of messages between a manager and a subordinate, such as text messages, emails, or chat logs, in order to evaluate the content of such exchanges.

The term “harassment” refers to inappropriate, offensive, or harmful expressions or behaviors in communication, including but not limited to expressions that may constitute power harassment, sexual harassment, or other unlawful or undesirable conduct in the workplace.

The term “inappropriate expressions” refers to words, phrases, or sentences that are determined, according to predetermined rules or models, to be offensive, discriminatory, threatening, excessively aggressive, or otherwise unsuitable for proper workplace communication.

The term “guidelines” refers to rules, templates, recommendations, or example sentences provided by the system to assist the user in clarifying and structuring the content of instructions given to a subordinate.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

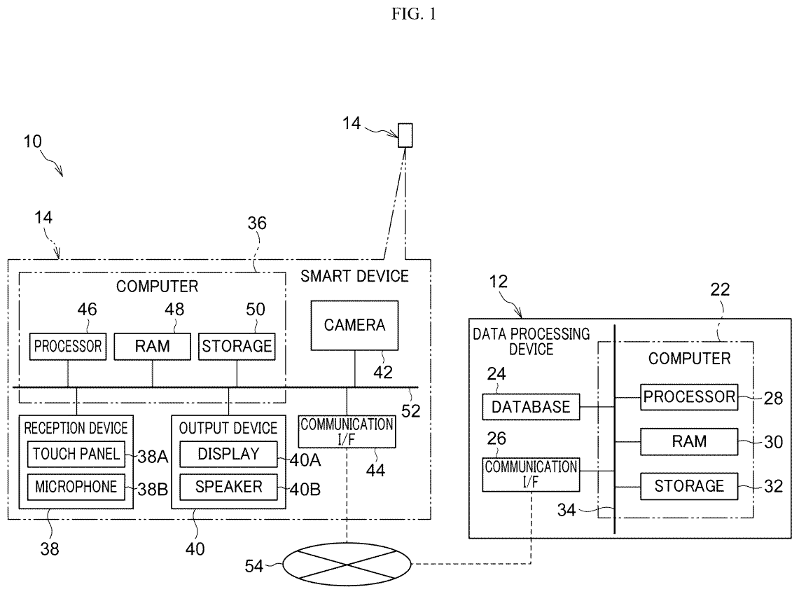

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

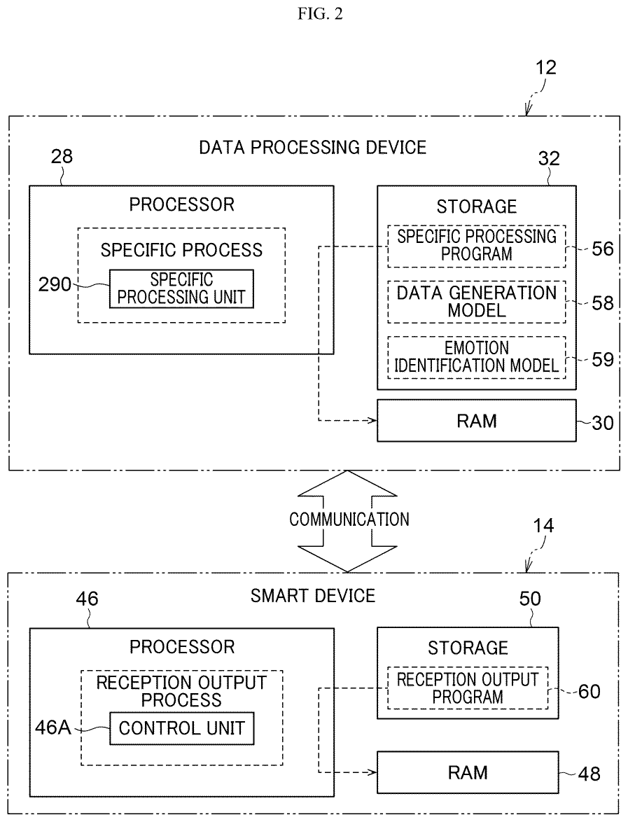

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional communication support systems that assist managers in drafting messages to subordinates typically focus on simple text templates, canned phrases, or keyword-based filters. Such systems do not fully exploit machine learning capabilities to dynamically adapt wording to individual subordinate attributes such as age group or gender, or to specific communication contexts such as instructions versus feedback. As a result, these systems often produce messages that are either too generic or inappropriate in tone, which can lead to misunderstandings, reduced clarity of instructions, and potential issues related to harassment or perceived disrespect in professional environments.

Furthermore, existing natural-language generation services that rely on generative AI models are usually invoked in an ad hoc and stateless manner. A client submits a free-form prompt and receives a generated text, but the system does not systematically (i) construct prompt sentences based on structured profile data and explicit tone constraints, (ii) perform automated safety and policy evaluation of the generated expressions, or (iii) feed back user edits and historical interactions into the prompt construction logic. Consequently, the generative AI model may generate inconsistent, overly casual, or insufficiently clear expressions, and the system cannot effectively learn from past interactions to improve future generations.

In addition, traditional harassment-prevention and compliance-monitoring tools often operate independently from generative text systems, and are commonly based on static blacklists or rule sets applied to finalized messages. Such an architecture fails to integrate harassment detection into the generation pipeline itself, resulting in reactive rather than proactive control. It also does not support fine-grained adjustments of honorific level, politeness, or clarity before the message is presented to the user for final confirmation.

From a computer technology perspective, there is a need for an improved server-side processing architecture that (i) acquires and uses structured attribute information of subordinates, (ii) programmatically constructs context-rich prompt sentences for a generative AI model, (iii) automatically evaluates and adjusts AI-generated linguistic expressions according to multiple criteria including politeness, casualness, clarity, and harassment risk, and (iv) stores detailed interaction logs so that the prompt generation logic and guidelines can be iteratively refined. Such an architecture should improve the technical functioning of the communication support system by enabling more accurate, context-appropriate, and policy-compliant message generation with reduced user burden and reduced risk of inappropriate wording.

The specific processing by the specific processing unit 290 of the data processing device 12 in Example 1 is realized by the following means.

The present invention provides a server comprising a processor configured to acquire attribute information of a subordinate and identify the subordinate based on management information including the attribute information; generate, based on character information relating to an instruction or feedback input by a manager via a terminal, the attribute information of the identified subordinate, and conditions relating to a type of communication and a tone of wording, a structured prompt sentence to be input to a generative AI model; input the generated prompt sentence to the generative AI model and cause the generative AI model to generate a linguistic expression corresponding to the attribute information of the subordinate and the conditions; execute a content evaluation process on the generated linguistic expression to detect an inappropriate expression or an expression corresponding to harassment, and correct or regenerate the linguistic expression based on a result of the content evaluation process; evaluate the linguistic expression by applying criteria relating to honorific expressions, a level of politeness, a level of casualness, and clarity of an instruction content, and automatically adjust at least one of a tone or a representation format of the linguistic expression based on a result of the evaluation; transmit the corrected or regenerated linguistic expression to the terminal and present the corrected or regenerated linguistic expression on the terminal as a proposed message that is viewable and editable by the manager; automatically generate guideline information relating to concretization of terminology, reduction of ambiguous expressions, and avoidance of prohibited expressions based on the instruction or feedback input by the manager, the attribute information of the subordinate, and the linguistic expression generated by the generative AI model, and present the guideline information on the terminal together with the linguistic expression; and store, as record information, a final message after editing by the manager, original input character information corresponding to the final message, the attribute information of the subordinate, and a proposal history by the generative AI model in association with each other, and update at least one of generation conditions of the prompt sentence or the guideline information based on the record information. This enables an improvement in computer-based communication support by allowing the server to automatically construct context-aware prompt sentences, generate and refine policy-compliant linguistic expressions tailored to subordinate attributes and communication context, and iteratively optimize generation behavior using stored interaction histories, thereby enhancing the technical performance, reliability, and safety of the overall message-generation process.

The term “processor” refers to a hardware execution unit, such as a central processing unit or other computation circuitry, that executes instructions of one or more programs to perform data acquisition, analysis, generation, evaluation, storage, and control operations described in this specification.

The term “terminal” refers to an information processing apparatus, such as a client computer, mobile device, or other user interface device, that transmits input information from a manager to a server and presents generated information or guideline information to the manager.

The term “manager” refers to a user who has a supervisory role in an organization and who inputs instructions or feedback intended for a subordinate via the terminal.

The term “subordinate” refers to a person in an organization who receives instructions or feedback from the manager and whose attribute information is used to generate an adapted linguistic expression.

The term “attribute information” refers to profile information regarding a subordinate, including at least one of an age, an age group, a gender, a position, a role, or other demographic or organizational characteristics used to tailor a linguistic expression.

The term “management information” refers to structured data maintained by the system that associates identifiers of subordinates with attribute information and optionally with organizational roles, groups, or relational data used to identify a target subordinate.

The term “character information” refers to text data representing content of an instruction or feedback input by the manager, including a sequence of characters or symbols suitable for processing by the processor.

The term “instruction” refers to a directive message from the manager that requests a specific task, behavior, or action from the subordinate.

The term “feedback” refers to an evaluative or advisory message from the manager that comments on, assesses, or suggests improvements to the work or behavior of the subordinate.

The term “type of communication” refers to a classification of a message context, including at least whether the message is an instruction, feedback, or another category of managerial communication.

The term “tone of wording” refers to stylistic characteristics of a linguistic expression, including levels of formality, politeness, directness, and casualness.

The term “prompt sentence” refers to a structured input text, including context, attribute information, and constraints, that is provided to a generative AI model to cause the generative AI model to generate a desired linguistic expression.

The term “generative AI model” refers to a machine-learned model, such as a neural network based language model, configured to generate natural language text in response to an input prompt sentence.

The term “linguistic expression” refers to a generated natural language sentence or sequence of sentences that express the manager's intent toward the subordinate, tailored based on attribute information and communication conditions.

The term “content evaluation process” refers to an automated analysis performed by the processor on a linguistic expression to detect characteristics such as inappropriate expressions, harassment-related expressions, insufficient politeness, or ambiguity, according to predetermined rules or models.

The term “inappropriate expression” refers to a phrase or wording that is determined to violate predetermined standards of politeness, professionalism, or corporate policy.

The term “expression corresponding to harassment” refers to a wording that is determined to be discriminatory, insulting, threatening, or otherwise unacceptable under harassment-prevention policies or legal standards.

The term “correct or regenerate” refers to a process in which the processor modifies part or all of a generated linguistic expression, or requests the generative AI model to re-generate a new linguistic expression, based on results of evaluation or detection.

The term “honorific expressions” refers to language forms that express politeness or respect in accordance with cultural or organizational norms, including the use of polite forms, respectful titles, and deferential phrasing.

The term “level of politeness” refers to a degree to which a linguistic expression conforms to polite language norms, ranging from casual to highly formal.

The term “level of casualness” refers to a degree to which a linguistic expression employs informal, colloquial, or relaxed wording as opposed to formal or rigid phrasing.

The term “clarity of an instruction content” refers to how unambiguous, specific, and understandable the directive part of a message is for the subordinate.

The term “tone” refers to an overall impression conveyed by a linguistic expression, including emotional nuance, formality level, and interpersonal stance.

The term “representation format” refers to structural or stylistic aspects of a linguistic expression, such as sentence length, phrase ordering, or use of bullet points or paragraphs.

The term “proposed message” refers to a linguistic expression generated or adjusted by the system and presented to the manager prior to final confirmation, enabling review and editing.

The term “guideline information” refers to explanatory or advisory text generated by the system that instructs the manager on how to concretize terminology, reduce ambiguity, and avoid prohibited expressions when drafting messages.

The term “concretization of terminology” refers to a process or guidance that replaces vague or abstract words with more specific, detailed, or descriptive terms.

The term “reduction of ambiguous expressions” refers to a process or guidance that removes or refines wording that may have multiple interpretations, to make the message more precise and understandable.

The term “avoidance of prohibited expressions” refers to a process or guidance that identifies and omits words or phrases that are prohibited by policy, law, or organizational rules.

The term “record information” refers to stored data including at least a final message edited by the manager, original character information, attribute information of the subordinate, and proposal history associated with the generative AI model.

The term “final message” refers to a message that results from the manager's review and editing of a proposed message and that is considered the definitive content to be used in communication with the subordinate.

The term “original input character information” refers to the initial text content input by the manager before any processing or generation by the system.

The term “proposal history” refers to a chronological or logical record of one or more linguistic expressions generated by the generative AI model, including intermediate versions and associated evaluation results.

The term “generation conditions of the prompt sentence” refers to parameters, rules, or templates used by the processor when constructing a prompt sentence, including mappings from attribute information, communication type, and tone to prompt structure and constraints.

The term “guideline” refers to a set of rules, patterns, or recommendations that govern how the system should construct prompt sentences or adjust linguistic expressions to meet communication and policy objectives.

In one embodiment, a server cooperates with a terminal operated by a user to implement a communication support system that generates and refines messages from a manager to a subordinate. The server includes at least one processor, a memory, a storage device, and a network interface. The processor can be implemented by a general-purpose central processing unit such as a multicore server-class processor, and the server can be deployed on a network computing environment such as a data center or a cloud computing platform. The terminal includes a processor, a display, an input device such as a keyboard or a touch panel, and a communication module, and can be implemented by a personal computer, a smartphone, or a tablet device.

The server executes an application program stored in the memory to implement the functions described in the claims. In one concrete implementation, the server runs a web server program and an application framework such as a general-purpose web application framework, and the generative AI model is executed either as a remote model accessed via an application programming interface or as a local model running on an accelerator such as a graphics processing unit. The server stores subordinate attribute information, communication logs, and model configuration data in a relational database management system such as a general-purpose SQL-based database.

The terminal presents a graphical user interface to the user who acts as a manager. The user operates the terminal to input text representing an instruction or feedback directed to a subordinate. The terminal converts the input into structured data and transmits it to the server through a secure network connection. The terminal later receives a proposed message and guideline information from the server and displays them to the user for review and optional editing.

The server uses structured data representations to manage subordinate information and communication context. In one embodiment, the server stores for each subordinate a record including a subordinate identifier, an age group attribute, a gender attribute, and optional role or position attributes. The server additionally maintains configuration tables that map combinations of age group, gender, communication type, and required politeness level to tone profiles and generation conditions for a prompt sentence. Each tone profile can include parameters such as desired length of sentences, allowable degree of directness, and requirements for using honorific expressions.

The server generates a prompt sentence for a generative AI model using explicit data structures and algorithmic rules. In one embodiment, the server constructs a prompt sentence by concatenating a system context portion, a subordinate profile description portion, and a manager intent portion. The system context portion defines the role of the generative AI model and sets high-level constraints, the subordinate profile description portion describes age group, gender, and position of the subordinate, and the manager intent portion contains the content of the original instruction or feedback. The server uses a template library in which each template is parameterized by attributes such as communication type and desired tone. The server selects a template from the library based on the subordinate attributes and communication conditions and then fills placeholder fields with concrete values.

For example, the server may generate a prompt sentence such as:

“You are a generative AI model that rewrites manager messages to subordinates in a corporate environment. The subordinate is a male in his 20s. The manager wants to send an instruction. Rewrite the following message into a natural, casual but respectful Japanese sentence that avoids offensive or harassing expressions and keeps the meaning accurate.

Original message: ‘Please check the progress of the next project.’”

In another example, the server may generate a prompt sentence such as:

“You are a generative AI model that creates formal feedback messages from a manager to a subordinate in a corporate environment. The subordinate is a female in her 50s. The manager wants to provide constructive feedback about report quality. Rewrite the following intent into a polite and formal Japanese sentence that avoids any wording that may be perceived as harassment. Original intent: ‘I want to give feedback on the report quality.’”

The server uses a generative AI model that is implemented as a neural network-based language model, for example a transformer architecture. The model includes an embedding layer that converts each token in the prompt sentence into a vector representation, multiple attention blocks each including multi-head self-attention and position-wise feedforward networks, and an output layer that generates probability distributions over candidate next tokens. The server stores model parameters such as weight matrices and bias vectors in a model storage unit and loads them into memory when performing inference. In one training embodiment, the generative AI model is pre-trained on a large corpus of text data using an objective such as next token prediction or masked language modeling. The server may further fine-tune the model on a domain-specific dataset comprising manager-subordinate communications, where each training example pairs an input text and context metadata with an output text representing an appropriate expression. During training, the server computes a loss function, such as cross-entropy between the predicted token distribution and the reference token, and updates the model parameters using an optimization algorithm such as stochastic gradient descent or a variant with adaptive learning rates. The server may apply regularization techniques such as dropout or weight decay and may augment training data by paraphrasing sentences or varying politeness levels while preserving semantic intent to increase robustness.

The server processes the prompt sentence by first tokenizing the prompt sentence into tokens using a tokenizer associated with the model. The server converts the tokens to numerical identifiers and then to embeddings. The server passes the embeddings through the transformer layers, performing matrix multiplications and non-linear transformations on a processor such as a central processing unit or a graphics processing unit. For each decoding step, the server computes a probability distribution over the vocabulary and selects a token according to a decoding policy such as greedy decoding or sampling with temperature and top-k filtering. This sequence of operations produces a candidate linguistic expression.

The server then applies a multi-stage content evaluation process to the candidate linguistic expression. In one embodiment, the server uses a combination of rule-based filters and a classifier model. The server first applies character-level and word-level filters to detect prohibited terms or patterns stored in policy rule tables. The server then applies a classifier model that estimates a harassment risk score, a politeness score, a casualness score, and a clarity score. The classifier model can be implemented as a smaller neural network that takes as input features derived from the linguistic expression, such as token embeddings, sentence length, and syntactic patterns, and outputs score values. The server compares these scores against predetermined thresholds stored in configuration memory.

If any score is outside the acceptable range, the server modifies the linguistic expression. The server may remove or replace specific words identified by the rule-based filters or may generate a secondary prompt sentence instructing the generative AI model to correct specific issues. For example, the server may generate a secondary prompt sentence such as: “The following sentence may be too casual or ambiguous. Rewrite it into a clearer and more polite sentence while keeping the same meaning and avoiding harassment: ‘[generated sentence]’.”

By iteratively evaluating and adjusting the expression, the server converges to a message that satisfies policy constraints and tone requirements. The server stores intermediate results and evaluation scores in structured logs, which allows analysis of model behavior and tuning of thresholds to balance politeness, clarity, and naturalness.

The server also generates guideline information for the user. The server analyzes the original input text and the final proposed message to identify differences that correspond to concretization of terminology, reduction of ambiguity, or removal of prohibited expressions. The server may compute alignment between tokens in the original text and the final text using a sequence alignment algorithm. Based on this comparison, the server extracts examples of vague terms that were made specific and lists them in a guideline message. For example, the server may generate guidance such as “Specify which project phase to check (e.g., design, implementation, or testing)” or “Avoid expressions that could be interpreted as blaming; use neutral descriptions of issues.” The terminal displays this guideline information next to the proposed message, allowing the user to understand the system's modifications and learn improved communication patterns.

The server stores, for each communication session, record information including the original input character information, the subordinate attribute information, the generated candidate expressions, associated evaluation scores, the final message after editing by the user, and the guideline information presented to the user. The server indexes this record information by subordinate identifier, manager identifier, and timestamp, enabling efficient retrieval. The server periodically analyzes the stored records to adjust generation conditions, such as mapping from attribute combinations to tone profiles, and to refine prompt sentence templates. For example, if the server detects that users consistently edit generated sentences to increase directness for subordinates in certain roles, the server modifies the default tone parameters for those roles. This feedback loop improves the technical performance of the system by reducing the number of generations and edits required to obtain an acceptable message.

The server architecture and processing provide technical effects beyond mere automation of human drafting. By using structured attribute information, parameterized prompt templates, and multi-criteria evaluation, the server reduces the variability and error rate of generated expressions, thereby decreasing the number of round trips between the terminal and the server and reducing network traffic. The server also shortens the time needed to obtain a compliant message, improving overall processing speed from the perspective of the communication workflow. Furthermore, by centralizing log data and using it to refine prompt generation and evaluation rules, the server enhances data management and allows the system to adapt to evolving corporate policies without requiring manual reconfiguration of every client.

The server implements non-conventional processing sequences that differ from typical manual drafting or simple rule-based systems. The server does not merely replace human judgment; instead, the server imposes explicit numerical criteria on politeness and clarity and enforces harassment-prevention policies at the level of the generative model's outputs before the messages are presented to the user. The transformer-based generative AI model combined with the classifier and rule-based filters forms a multi-module pipeline in which each module contributes specific technical improvements: the generative model ensures fluent natural language generation conditioned on structured context, the classifier evaluates subtle tone characteristics, and the rule engine enforces hard constraints. The combined pipeline yields more stable and predictable behavior than ad hoc use of a generative AI model alone.

The terminal and server also cooperate to reduce computational load and latency. The terminal performs user interface rendering and simple validations locally, while the server performs heavy inference computations on dedicated processors optimized for parallel numerical operations. By centralizing model execution on the server, the system avoids duplicating large model parameters on multiple terminals and thus improves memory utilization and update management. In alternative embodiments, the generative AI model may be executed on an edge server closer to the user to further reduce latency, or may be split into a lightweight model on the terminal for preliminary rewriting and a larger model on the server for final refinement.

In another embodiment, the server uses different generative AI models for different languages or domains, selecting a model based on metadata such as language preference or department. The server may also vary the model size and decoding strategy depending on the required response time, using a smaller model for time-critical interactions and a larger model for offline batch generation of suggestion templates. The server can also incorporate additional features derived from communication history, such as the subordinate's past reactions or preferences, as input to the prompt sentence, further refining personalization while still controlling tone and policy compliance through the evaluation module.

By combining structured subordinate attributes, template-based prompt construction, transformer-based generation, multi-criteria evaluation, and feedback-driven refinement of rules and templates, the server provides an improved computer-centric mechanism for generating and managing manager-subordinate communications. This mechanism enhances the accuracy, consistency, and safety of generated messages and reduces processing time and user intervention, thereby improving the functioning of the communication support system as a whole.

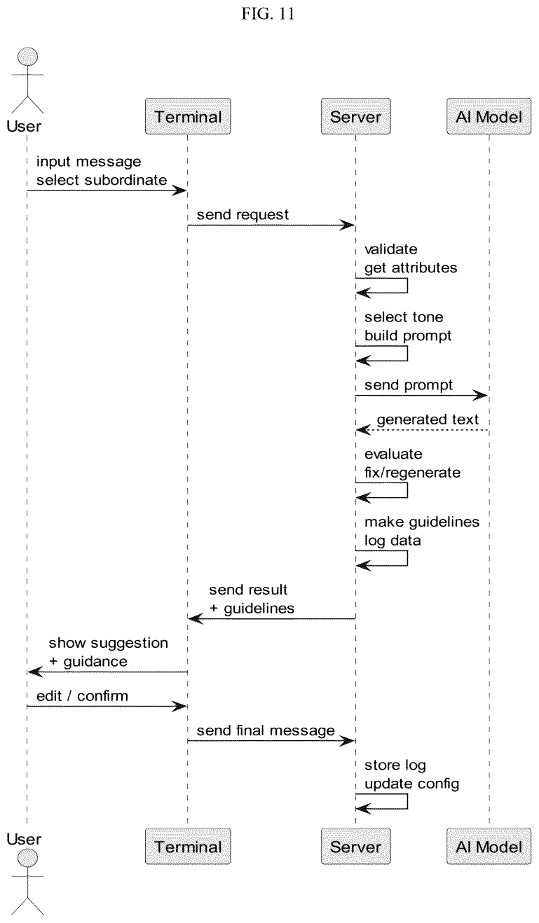

The following describes the processing flow using FIG. 11.

### Step 1

User operates the terminal to input an original message and select a subordinate.

User opens an application screen on the terminal and types text representing an instruction or feedback, such as “Please check the progress of the next project.” User also selects a target subordinate from a list or by entering an identifier.

Input: raw text of the instruction or feedback, subordinate selection, and optional metadata (for example, message type =instruction or feedback).

Output: a structured input object on the terminal containing the text, subordinate identifier, and metadata.

Terminal converts the user's keystrokes or touch input into text data, packages the data into a structured object in memory (for example, a dictionary or record), and prepares it for transmission.

### Step 2

Terminal transmits the structured input to the server.

Terminal sends the structured input object to the server via a network interface, using a communication protocol such as HTTP over a secure channel. Terminal includes fields for the user identifier, subordinate identifier, message type, and original text.

Input: structured input object stored in terminal memory.

Output: network request containing the structured input delivered to the server.

Terminal encodes the structured object into a sequence of bytes according to a serialization format (for example, text-based or binary) and writes the bytes to a network socket addressed to the server.

### Step 3

Server receives and validates the incoming request.

Server accepts the network request through a server application, reads the serialized data, and reconstructs the structured input object in server memory. Server checks presence and validity of required fields, such as subordinate identifier, message type, and non-empty text.

Input: serialized request data arriving over the network.

Output: validated internal data structure representing the manager's input and corresponding subordinate.

Server parses the received data, performs type checks (for example, that the subordinate identifier is numeric or conforms to a defined format), and rejects or flags the request if mandatory elements are missing or malformed.

### Step 4

Server retrieves subordinate attribute information from storage.

Server uses the subordinate identifier as a key to query a persistent data store that maintains subordinate profiles. Server executes a data-access operation to fetch attributes such as age group, gender, position, and any communication preferences.

Input: subordinate identifier extracted from the validated input object.

Output: subordinate attribute record containing age group, gender, and optional additional attributes.

Server generates a query expression, sends it to the data store, receives the result set, and maps the returned fields into an internal structure (for example, an attribute map) associated with the subordinate.

### Step 5

Server determines communication type, tone profile, and generation conditions.

Server analyzes the message type (instruction or feedback) and subordinate attribute information to select a tone profile and associated constraints. Server may use lookup tables that map combinations of age group and message type to parameters such as desired politeness level, allowed casualness, and required clarity thresholds.

Input: message type and subordinate attribute record.

Output: tone profile object containing numerical or categorical parameters (for example, politeness level=high, casualness level=low, clarity threshold=strict).

Server performs table lookups and conditional logic; for example, if the subordinate is in a younger age group and the message type is an instruction, server sets casualness level to medium, whereas for an older age group and feedback, server sets politeness and formality to high.

### Step 6

Server constructs a prompt sentence for the generative AI model.

Server composes a prompt sentence by combining interpretation of the manager's original text, subordinate attributes, and tone profile into a structured natural-language instruction.

Server selects a template from a stored set of templates based on communication type and tone profile, and fills placeholder slots (for example, {age group}, {gender}, {message type}, {original text}).

Input: original text, subordinate attribute record, and tone profile object.

Output: a prompt sentence in natural language instructing the generative AI model how to rewrite the message.

Server performs string concatenation and template substitution, for example inserting “male in his 20s” and “instruction” into a predefined prompt skeleton, and appending the original message inside a quoted section.

### Step 7

Server encodes and submits the prompt sentence to the generative AI model.

Server converts the prompt sentence into token identifiers using a tokenizer compatible with the generative AI model. Server packs the token sequence and model parameters (for example, maximum output length, temperature) into an inference request and submits the request to a model inference engine or an external AI service.

Input: prompt sentence string and model configuration parameters.

Output: a model request containing a tokenized prompt prepared for processing by the generative AI model.

Server runs a tokenization algorithm that maps word fragments or characters to integer IDs, builds a numeric vector of these IDs, and forwards it to the model execution environment.

### Step 8

Server executes generative inference to obtain a candidate linguistic expression.

Server causes the generative AI model to perform forward passes through its neural network layers using the tokenized prompt as input. Server computes embedding vectors, attention scores, and layer outputs step by step until the model generates a sequence of output tokens representing the suggested message.

Input: tokenized prompt and model weights stored in memory.

Output: token sequence for a candidate linguistic expression.

Server performs matrix multiplications and non-linear transformations across multiple transformer blocks; for each decoding step, server calculates a probability distribution over the vocabulary and selects a token according to a predefined decoding strategy (for example, greedy or sampling), continuing until an end-of-sequence token is produced.

### Step 9

Server decodes the token sequence into a text message.

Server converts the output token identifiers back into characters using the tokenizer's vocabulary mapping. Server concatenates the characters or subwords into a coherent sentence or paragraph.

Input: sequence of token identifiers generated by the generative AI model.

Output: candidate linguistic expression as a text string.

Server iterates over the token sequence, looks up each token's corresponding string in a vocabulary table, and joins these strings, inserting spaces or applying language-specific post-processing rules if necessary.

### Step 10

Server evaluates the candidate expression for policy compliance and tone.

Server applies a multi-stage evaluation algorithm to the candidate linguistic expression.

Server runs rule-based filters that search for prohibited words or patterns, then computes numerical scores for politeness, casualness, harassment risk, and clarity using a classifier model or heuristic metrics.

Input: candidate linguistic expression text.

Output: evaluation result including detection flags (for inappropriate or harassing content) and numerical scores for tone and clarity.

Server tokenizes the candidate text for analysis, matches against a stored list of restricted expressions, calculates text features such as sentence length and use of honorifics, and feeds these features into an evaluation module that outputs scores and flags.

### Step 11

Server corrects or regenerates the expression when necessary.

Server inspects the evaluation result and determines if any threshold is violated. If an issue is detected, server modifies the candidate expression or formulates a secondary prompt sentence instructing the generative AI model to adjust specific aspects (for example, “make more formal,” “remove potentially offensive wording,” or “increase clarity”).

Input: candidate linguistic expression and associated evaluation result.

Output: corrected linguistic expression or a new candidate expression generated after a secondary inference.

Server may perform direct edits by replacing offending terms with neutral alternatives using a rule-based mapping, or generate a secondary prompt and repeat the tokenization and inference sequence to obtain an improved version, then reevaluate until an acceptable expression is produced or a retry limit is reached.

### Step 12

Server generates guideline information based on differences between original and final expressions.

Server compares the original input text and the final corrected expression to identify linguistic transformations such as concretization of vague terms, removal of ambiguity, and avoidance of prohibited expressions. Server constructs guideline sentences that explain these transformations to the user.

Input: original input text and final corrected linguistic expression.

Output: guideline information text describing recommended drafting practices.

Server performs a comparison operation, for example computing an alignment between token sequences, marking segments that changed, categorizing changes into types (for example, “added detail,” “softened wording”), and generating natural-language explanations referencing these categories.

### Step 13

Server creates a response package containing the final expression and related metadata.

Server bundles the final expression, subordinate attributes used for generation, tone profile details, evaluation scores, and guideline information into a structured response object.

Input: final corrected linguistic expression, subordinate attribute record, tone profile, evaluation results, and guideline information.

Output: response object ready to be transmitted to the terminal.

Server assembles fields in a defined structure, assigns identifiers, and serializes the data into a sequence of bytes suitable for network transmission.

### Step 14

Server transmits the response package to the terminal.

Server sends the serialized response object to the terminal via the network interface using a communication protocol such as HTTP response messages.

Input: serialized response package.

Output: network data stream delivered to the terminal.

Server writes the response bytes into the network socket associated with the original request session and signals completion of the server-side processing for that request.

### Step 15

Terminal receives and interprets the server response.

Terminal reads the incoming data stream, reconstructs the response object in terminal memory, and extracts the final expression and guideline information.

Input: serialized response data arriving over the communication channel.

Output: internal representation of the final expression, guideline text, and metadata on the terminal.

Terminal deserializes the response by applying a parsing routine, maps each field into local variables or data structures, and prepares the data for display.

### Step 16

Terminal displays the final expression and guidelines to the user.

Terminal renders the final corrected linguistic expression in a text display element and presents guideline information in an adjacent area, such as a help panel or tooltip.

Input: final expression text and guideline text.

Output: visual presentation on the display device, showing the proposed message and its explanations.

Terminal invokes a user interface framework to place the text in designated components, updates the screen buffer, and instructs the display hardware to refresh the visible content.

### Step 17

User reviews, optionally edits, and confirms the message.

User reads the proposed message and the associated guidelines. User may edit the proposed message directly in an input field, adjusting wording to match personal preference while observing the guidelines provided. User then confirms or approves the final message.

Input: proposed message displayed on the terminal and guideline information.

Output: user-edited final message and a confirmation action.

Terminal records any modifications made by the user, updates the local text value, and upon confirmation, sends the edited final message and associated identifiers (such as subordinate identifier and session identifier) back to the server.

### Step 18

Server logs the interaction and updates generation conditions.

Server receives the user-confirmed final message, along with the original input, subordinate attributes, generated suggestions, and evaluation data. Server writes a log record that links these elements in persistent storage. Server analyzes aggregated logs over time to detect systematic patterns in user edits and uses these patterns to adjust tone profile parameters and prompt templates.

Input: user-confirmed final message, original input text, subordinate attribute record, candidate expressions, and evaluation results.

Output: stored log entry and updated configuration for future prompt and tone determination.

Server inserts the log entry into a database table indexed by manager and subordinate identifiers, runs scheduled or on-demand analytics jobs that compute statistics such as average number of edits or common adjustment types, and modifies configuration records controlling tone levels and template selection. This adjustment reduces the need for repeated corrections in subsequent sessions and improves the overall efficiency and consistency of the generative AI model's outputs.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional human-machine communication systems in industrial environments typically generate uniform responses that do not take into account individual worker attributes, such as age group and gender, or the detailed semantic content of work instructions. As a result, these systems often produce feedback that is either too formal, too casual, or otherwise inappropriate for a specific worker, which can reduce comprehension and acceptance of instructions and ultimately degrade operational efficiency. Moreover, many existing systems treat natural language understanding and response generation as separate, loosely integrated components, leading to increased processing latency, redundant data handling, and difficulty in consistently controlling tone and politeness levels across different interaction channels.

From a computer technology standpoint, there is a need for an improved data processing architecture that tightly integrates: (i) retrieval and analysis of worker attribute information from storage, (ii) semantic analysis of work instructions using a language model, and (iii) controlled generation of feedback sentences using a generative AI model based on a structured prompt sentence. Without such an integrated architecture, the system cannot reliably perform fine-grained style control or systematically log the entire prompt-and-response pipeline for subsequent optimization.

Furthermore, conventional systems often lack mechanisms for systematically recording prompt sentences and generated feedback as machine-readable log information. This limitation prevents effective, data-driven refinement of models and rules used in communication, and limits the ability to diagnose failures or biases in feedback generation. In addition, the absence of a unified processor-controlled flow results in fragmented implementations that are harder to scale, maintain, and optimize on modern computing hardware.

Accordingly, there is a demand for a computer-implemented system that improves the technical field of human-machine communication by implementing, within a processor, a specific sequence of data acquisition, natural language analysis, prompt construction, generative AI invocation, and logging operations. Such a system should improve the accuracy and adaptability of generated feedback while reducing processing complexity and enabling systematic evaluation and improvement of the communication process itself.

The specific processing by the specific processing unit 290 of the data processing device 12 in Application Example 1 is realized by the following means.

The present invention provides a server comprising a processor configured to acquire worker attribute information from a storage device based on worker identification information and to analyze the worker attribute information, to analyze text data of a work instruction from the worker by using a natural language processing language model and to generate structured data including action information and target information of the work instruction, to generate a prompt sentence for input to a generative AI model based on the worker attribute information and the structured data, to input the prompt sentence to the generative AI model to generate a feedback sentence for the worker while controlling at least a writing style and a politeness level according to the worker attribute information, and to store the prompt sentence and the feedback sentence as log information in association with the worker identification information. This enables an integrated computer-implemented pipeline that improves human-machine communication by generating worker-adaptive feedback with reduced processing overhead and by providing machine-readable records that support systematic evaluation, tuning, and technical optimization of the underlying language processing and generative models.

The term “worker” refers to a human operator who performs tasks in an operational environment and issues work instructions to a machine or system.

The term “identification information” refers to data that uniquely identifies a worker within a system, such as an identifier, code, or account information.

The term “attribute information” refers to data indicating characteristics of a worker, including at least age-related information, gender-related information, or other profile-related parameters used for customizing feedback.

The term “information storage device” refers to any hardware or combination of hardware and software configured to store data, such as a database system, a memory device, or a storage subsystem.

The term “processor” refers to one or more hardware processing units configured to execute instructions, including a central processing unit, a graphics processing unit, or a specialized accelerator.

The term “text data of a work instruction” refers to character-based information representing a worker's instruction expressed in natural language.

The term “natural language processing language model” refers to a computational model configured to analyze or process natural language input and to generate outputs such as token representations, semantic features, or structured information.

The term “structured data” refers to data formatted in a predefined structure, such as a dictionary, record, or object, including explicit fields representing at least action information and target information of a work instruction.

The term “action information” refers to data indicating an operation or task to be performed, extracted from a work instruction.

The term “target information” refers to data indicating an object, component, or subject on which an action is to be performed, extracted from a work instruction.

The term “prompt sentence” refers to a textual sequence constructed for input to a generative AI model, the sequence including contextual information derived from worker attribute information and structured data of a work instruction.

The term “generative AI model” refers to a computational model configured to generate natural language text based on an input sequence, including but not limited to large language models.

The term “feedback sentence” refers to a natural language response generated by a generative AI model and intended to be presented to a worker as a system or machine response.

The term “writing style” refers to characteristics of expression in a feedback sentence, including at least formality level, vocabulary selection, and tone.

The term “politeness level” refers to a degree of deference, courtesy, or formality expressed in a feedback sentence and controlled based on worker attribute information.

The term “output control device” refers to hardware or a combination of hardware and software that controls presentation of information to a worker, including display devices, audio output devices, or interface controllers.

The term “machine” refers to an apparatus, equipment, or automated system configured to perform a task in response to a work instruction and to output a response via an output control device.

The term “log information” refers to data recorded for monitoring or analysis, including at least a prompt sentence, a feedback sentence, and optionally associated identification information or timestamps.

The term “communication between the worker and the machine” refers to an exchange of information in which a worker provides a work instruction and the machine provides a corresponding response or feedback.

In one embodiment, a server executes a program that realizes the claimed system by cooperating with at least one terminal operated by a user and at least one machine installed in an industrial environment. The server includes at least one processor, a main memory, and a non-volatile storage device. The server further communicates with an information storage device that implements a database, and with an output control device associated with the machine, via a communication network.

The server stores, in the non-volatile storage device, a worker management module, a natural language analysis module, a prompt generation module, a generative feedback module, and a logging and evaluation module. The server loads these modules into the main memory and executes them on the processor. The server uses an operating system such as a general-purpose server operating system, and uses middleware such as a relational database management system and a communication framework implementing secure communication protocols.

The server manages worker attribute information in the database. The server assigns to each worker an identification information, such as an alphanumeric identifier, and stores in association with the identification information at least an age-related attribute and a gender-related attribute. The server may additionally store other attribute information, such as language preference or skill level, as extended attributes. The database may be implemented as a relational database, and the server may store attribute information in records of a worker table.

The terminal presents a user interface that allows a user to register or update attribute information. The terminal sends the attribute information and the identification information of the user to the server over the network. The server receives the attribute information, validates data types and allowed ranges, and writes the attribute information into the database. By structuring the attribute information in this way, the server can subsequently retrieve the information with low latency by using indexed queries, which improves processing speed and reduces communication overhead compared with re-sending the full profile with every instruction.

The server receives, from the terminal or from a control interface of the machine, text data of a work instruction expressed in natural language. If the user provides a spoken instruction, the terminal converts speech into text using a speech recognition engine and sends the resulting text to the server. The server treats the received text as input to the natural language analysis module.

The server uses a natural language processing language model implemented as a neural network-based encoder. In one embodiment, the server employs a transformer-based encoder model having multiple layers of self-attention and feed-forward sublayers. The server stores, in the non-volatile storage device, parameter values of the model that have been trained in advance on a large corpus of text data. The server loads the parameter values into main memory and executes inference on the processor, optionally using a graphics processing unit configured to accelerate matrix multiplications and attention computations.

The server converts the work instruction text into a sequence of tokens by using a tokenizer corresponding to the transformer-based encoder. The tokenizer maps characters and words into integer token identifiers. The server then generates, as input features, token identifier sequences and position indices, and feeds them to the encoder model. The encoder model computes contextual vector representations for each token by repeatedly applying multi-head self-attention and non-linear transformations. The server obtains, from the encoder output, a sequence of contextual embeddings.

The server applies a classification layer or a sequence labeling layer on top of the contextual embeddings to derive structured data from the work instruction. The server uses a parameterized linear transform and a non-linear activation to map the embeddings to a predefined semantic space, and uses a loss function such as cross-entropy during training to align outputs with labeled action and target categories. For inference in the deployed system, the server uses the trained weights to predict, from the encoder outputs, at least action information and target information. The server formats this information as structured data including explicit fields representing the operation to be performed and the object of the operation. Because the server uses distributed representations and attention mechanisms, the server can robustly resolve references such as “this part” from context, which reduces misinterpretation compared with simple keyword-based systems.

The server retrieves, from the database, attribute information of the worker based on the identification information that accompanies the work instruction. The server obtains, at minimum, the age-related attribute and the gender-related attribute. The server represents these attributes as key-value pairs in internal memory and passes them to the prompt generation module.

The server generates a prompt sentence for a generative AI model by combining the attribute information and the structured data derived from the work instruction. The server constructs the prompt sentence according to a predetermined template that encodes style control rules.

For example, when the worker's age group is a younger range and the worker's gender attribute is a particular category, the server inserts into the prompt explicit instructions to use a casual and friendly tone. When the worker's age group is an older range, the server inserts instructions to use a polite and formal tone.

In one example, the server generates the following prompt sentence for a worker in a younger age group and a particular gender:

“The worker's age group is 20s and the worker's gender is male.

The instruction content from the worker is: ‘Assemble this part’.

Please generate an appropriate feedback sentence from a factory machine to this worker.

Use a casual and friendly tone suitable for a male worker in his 20s.”

In another example, the server generates the following prompt sentence for a worker in an older age group and a different gender:

“The worker's age group is 60s and the worker's gender is female.

The instruction content from the worker is: ‘Assemble this part’.

Please generate an appropriate feedback sentence from a factory machine to this worker.

Use a polite and formal tone suitable for a female worker in her 60s.”

The server thereby embeds, into the prompt sentence, explicit style and politeness constraints.

This explicit encoding allows the generative AI model to be controlled in a deterministic way that is linked to the stored attribute information, rather than relying on ad-hoc manual tuning.

The server uses a generative AI model implemented as a neural network-based language generator. In one embodiment, the server employs a transformer-based decoder or an encoder-decoder architecture that accepts the prompt sentence as input and outputs a probability distribution over tokens at each step of the output sequence. The server initializes the generative AI model with parameter values obtained by pre-training on large quantities of text data and optionally applies fine-tuning using domain-specific dialog data. During operation, the server performs inference by applying the model to the prompt sentence.

The server encodes the prompt sentence into token identifiers and position indices, feeds them into the generative AI model, and obtains, at each decoding step, a probability distribution over candidate next tokens. The server selects tokens according to a decoding strategy, such as greedy decoding, beam search, or sampling with temperature control, to generate a feedback sentence. The server continues decoding until a termination token is produced or a maximum length is reached. The server thus generates a feedback sentence that reflects both the semantics of the work instruction and the stylistic constraints encoded in the prompt sentence.

Because the server uses a transformer-based architecture with attention mechanisms, the server can maintain consistency across long feedback sentences and can modulate tone by conditioning on attribute-related instructions embedded in the prompt. This leads to improved alignment between worker attributes and generated feedback compared with conventional template-based responses, thereby improving comprehension and acceptance by the worker.

The server may implement additional rule-based post-processing to ensure that the feedback sentence conforms to safety, length, and wording constraints. For example, the server can apply a set of string-based filters or pattern-matching rules to suppress prohibited words, abbreviate excessively long sentences, or enforce inclusion of an acknowledgment phrase.

These rules are applied after generation, within the generative feedback module, before the server transmits the feedback sentence to the machine.

The server transmits the finalized feedback sentence to an output control device associated with the machine. The output control device may be implemented as an embedded controller or an industrial human-machine interface. The server sends the feedback sentence over a communication channel using a structured message format. The output control device then controls a display, a loudspeaker, or another output unit to present the feedback sentence as text or synthesized speech to the user. The terminal may also display, to the user, the same feedback sentence for confirmation.

The server additionally stores, as log information, at least the prompt sentence, the feedback sentence, the identification information of the worker, and optionally the structured data derived from the work instruction. The server writes this log information into the database with timestamps and correlation identifiers. The logging and evaluation module of the server can later scan these logs to evaluate communication patterns, measure response length and latency, and identify cases where attribute-based style control may need adjustment. Because the server preserves the exact prompt sentence and resulting feedback sentence, developers can re-run the generative AI model with modified parameters or templates to systematically improve model behavior, which constitutes a technical improvement in model lifecycle management and system maintenance.

The server thereby implements a specific data structure and data flow: worker attribute records in a database; token sequences and contextual embeddings in memory; structured action and target representations; and prompt sentences that concretely bind attributes and semantics. This structured pipeline reduces redundant lookup operations, enables caching of attribute information, and allows the server to reuse structured data across multiple feedback generations. As a result, the server reduces processing time for repeated instructions and decreases overall computational load on the generative AI model.

The server improves computer technology in several respects. First, the server reduces misinterpretation of work instructions and inappropriate tone by combining a transformer-based semantic analysis with explicit, attribute-conditioned prompt construction. This combination reduces error rates in generated feedback compared with systems that rely solely on manual templates or unconditioned generation. Second, the server improves processing efficiency by decoupling semantic extraction from style control: the natural language analysis module extracts action and target information once, in a compact structured form, and the prompt generation module reuses this structure to construct different prompt sentences under different styles without re-parsing the original text. This modularity reduces redundant inference calls and lowers computational cost.

Third, the server's logging and evaluation module enables technical optimization of the underlying models. Because the server stores prompt sentences and feedback sentences in association with worker attributes and actual machine responses, the server can support offline analysis such as re-calculation of model outputs, gradient-based retraining, and error statistics computation, using the same data structures that were used during live operation.

This tight coupling between runtime inference and offline optimization enhances data management and improves the accuracy of subsequent model versions.

The server uses, during training of the natural language processing language model and the generative AI model, standard neural network training procedures, including the definition of loss functions, such as cross-entropy or sequence-level losses, computation of gradients by backpropagation, and iterative update of weight parameters by optimization algorithms such as stochastic gradient descent or adaptive moment estimation. The server may apply data augmentation techniques, such as paraphrasing of work instructions, variation of attribute combinations, and random masking, to increase robustness. Although training may be performed offline on specialized hardware, the same architecture and data structures are used during runtime inference, ensuring that improvements from training directly benefit live performance.

The server implements style control through a non-conventional mechanism that leverages both explicit natural language instructions in the prompt sentence and internal weighting of style-related tokens by the generative AI model. The server can also apply a secondary scoring function to candidate feedback sentences, favoring candidates that include desired politeness markers or domain-specific terminology. This scoring function may be computed by a separate evaluation model or by hand-crafted metrics. This layered approach goes beyond simple automation of human editing and constitutes a specific technical procedure for controlling sequence generation.

The server thus provides a concrete, hardware-bound realization of the claimed system. The server executes well-defined data transformations and neural network computations that improve the precision, efficiency, and controllability of human-machine communication in an industrial setting. The terminal and the machine cooperate with the server to provide real-time feedback to the user, while the internal data structures and logging mechanisms ensure that the system can be systematically evaluated and optimized, thereby improving the underlying computer technology rather than merely automating a human communication task.

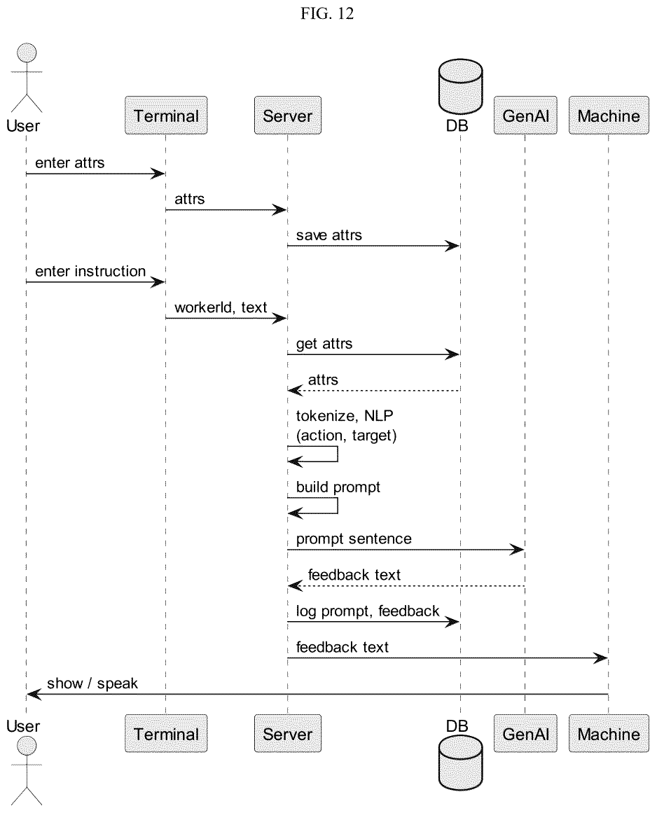

The following describes the processing flow using FIG. 12.

### Step 1

The user registers or updates attribute information through the terminal.

The terminal receives, as input, user selections or text entries such as age group, gender, and optional preferences. The terminal converts these UI inputs into structured data (for example, key-value pairs) and sends them to the server over a network connection. The output of this step is a structured attribute payload containing at least worker identification information and associated attribute information.

### Step 2

The server receives and stores the attribute information.

The server accepts, as input, the attribute payload from the terminal. The server validates data types, checks required fields, and normalizes values (for example, mapping “twenties” to a canonical age group label). The server then performs a data write operation to a database, inserting or updating a record that links the worker identification information to the normalized attribute fields. The output of this step is an updated attribute record stored in an information storage device, ready for later retrieval.

### Step 3

The user issues a work instruction via the terminal or a machine-side interface.

The terminal receives, as input, a natural language instruction from the user, either as typed text or as spoken words. If the instruction is spoken, the terminal invokes a speech recognition component to convert the audio signal into text data by applying acoustic modeling and language modeling algorithms. The terminal then attaches the worker identification information to the instruction text and outputs a structured message containing the identification information and the text data of the work instruction, which is transmitted to the server.

### Step 4

The server retrieves worker attribute information based on identification information.

The server receives, as input, the structured message containing the worker identification information and the work instruction text. The server uses the identification information as a lookup key and executes a query against the database. The server performs an indexed search to obtain the corresponding attribute record, which includes at least age-related information and gender-related information. The output of this step is an in-memory data structure (for example, a dictionary) containing the worker's attribute information.

### Step 5

The server tokenizes the work instruction text for natural language processing.

The server uses, as input, the work instruction text. The server applies a tokenizer associated with a transformer-based language model, splitting the text into subword tokens and mapping each token to an integer identifier. The server also computes position indices and attention masks as required by the model. The server thereby transforms raw character data into numerical token sequences and related arrays. The output of this step is a set of tokenized representations stored in memory, ready for further model inference.

### Step 6

The server computes contextual embeddings using a natural language processing language model.

The server takes, as input, the tokenized representations from Step 5. The server feeds these numerical arrays into a transformer encoder implemented as a neural network with multiple attention layers. The processor performs matrix multiplications, attention score calculations, and non-linear activations according to the model parameters. As a result, the server computes contextual embeddings that encode semantic relationships between tokens. The output of this step is a sequence of high-dimensional vectors representing the contextual meaning of each token in the work instruction.

### Step 7

The server extracts structured action and target information from contextual embeddings.

The server uses, as input, the contextual embeddings produced in Step 6. The server applies a classification layer or sequence labeling layer that maps each embedding vector to one of several semantic labels, such as action, object, or other. The processor computes class scores via linear transformations and softmax functions, and selects the most probable labels. The server then aggregates tokens with the same role to identify the action phrase and the target phrase. The server constructs structured data with explicit fields such as “action” and “target” and associates the original instruction text. The output of this step is structured data that captures action information and target information derived from the work instruction.

### Step 8

The server combines attribute information and structured instruction data.

The server receives, as input, the worker attribute information from Step 4 and the structured data from Step 7. The server merges these data sets into a unified internal structure by linking attribute fields (such as age group and gender) with semantic fields (such as action and target). The server may also compute derived fields, such as a style category based on age group, by applying predefined rules. The output of this step is a combined context object containing both attribute information and semantic representation of the work instruction.

### Step 9

The server generates a prompt sentence for the generative AI model.

The server uses, as input, the combined context object from Step 8. The server applies a template or rule set to convert the attribute information and the structured instruction data into natural language sentences. The server concatenates clauses describing the worker's age group and gender, the original instruction content, and explicit style constraints. For example, the server constructs a prompt sentence such as:

“The worker's age group is 20s and the worker's gender is male.

The instruction content from the worker is: ‘Assemble this part’.

Please generate an appropriate feedback sentence from a factory machine to this worker.

Use a casual and friendly tone suitable for a male worker in his 20s.”

The output of this step is a fully formed prompt sentence that encodes both semantic and stylistic requirements.

### Step 10

The server logs the prompt sentence and related metadata.

The server receives, as input, the prompt sentence from Step 9 along with the worker identification information and optionally the structured action-target data. The server writes these elements as a record into a log storage area in the database or another persistent storage.

The processor assigns a timestamp and a correlation identifier to support later retrieval and analysis. The output of this step is a persistent log entry linking the prompt sentence to the worker and the original instruction.

### Step 11

The server invokes the generative AI model with the prompt sentence.

The server uses, as input, the prompt sentence generated in Step 9. The server tokenizes the prompt sentence using a tokenizer appropriate for the generative AI model and encodes the tokens into numerical identifiers and auxiliary features. The server then sends these numerical inputs either to a local generative AI engine or to a remote inference service via a communication interface. The processor or external service executes a decoder or encoder-decoder neural network that computes probability distributions over output tokens and samples or searches for a likely sequence. The output of this step is a candidate feedback sentence generated by the generative AI model as token identifiers, which the server then decodes back into text.

### Step 12

The server post-processes the generated feedback sentence.

The server takes, as input, the raw text output from the generative AI model in Step 11. The server removes extraneous characters, normalizes whitespace, and applies rule-based filters to check for prohibited expressions or excessive length. If necessary, the server truncates or rephrases parts of the feedback sentence by applying predefined replacement rules. The server thus refines the generated text to conform to domain-specific constraints. The output of this step is a cleaned and validated feedback sentence suitable for presentation to the user.

### Step 13

The server stores the feedback sentence as part of log information.

The server uses, as input, the finalized feedback sentence from Step 12 together with the prompt sentence and worker identification information. The server performs a database write operation, appending the feedback sentence to the log record created in Step 10 or creating a new linked record. The server may also compute and store auxiliary metrics such as response length or processing time. The output of this step is an updated log that associates each prompt sentence with its corresponding feedback sentence and worker context.

### Step 14

The server sends the feedback sentence to the output control device and terminal.

The server receives, as input, the finalized feedback sentence from Step 12 and the address or identifier of the target machine or terminal. The server encapsulates the feedback sentence into a communication message and transmits the message over the network using a predefined protocol. The output of this step is a delivered message that arrives at the output control device and optionally at the terminal, containing the feedback sentence and any necessary metadata.

### Step 15

The terminal and the machine present the feedback to the user.

The terminal accepts, as input, the communication message from the server containing the feedback sentence. The terminal decodes the message and either displays the text on a screen or forwards the text to a text-to-speech component to generate an audio waveform. Similarly, the output control device of the machine receives the message and controls a display or speaker to present the feedback. The output of this step is a human-perceptible response, in text or audio form, that the user receives as a customized feedback aligned with the worker's attributes and the original work instruction.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented communication assistance systems that generate manager-to-employee messages using a generative AI model typically treat the generative AI model as a black box that simply transforms an input text into an output text. In such systems, the construction of a prompt sentence, the post-processing of the generated text, and the interaction between stored communication history and the generative AI model are often implemented as ad hoc business logic. As a result, these systems suffer from several technical problems in the way information is processed within the computing environment.

First, existing systems generally do not structurally integrate prompt sentence generation with explicit constraint conditions relating to harassment prevention and ease of understanding. The prompt sentence is often composed as an unstructured natural language query without a systematic representation of case information, event information, and safety constraints. This leads to unstable and inconsistent outputs from the generative AI model, increasing the need for manual review and rewriting by the user. From the standpoint of computer technology, this results in inefficient use of processing resources and network bandwidth because multiple trial-and-error calls to the generative AI model are required, and large volumes of intermediate data must be transmitted and stored.

Second, conventional systems typically lack an automatic feedback loop that evaluates the generated text in terms of inappropriate expressions and readability and then programmatically drives a regeneration or correction process. In many implementations, a user must visually inspect the output and manually decide whether to request another generation, which introduces human-dependent variability and latency. The absence of machine-executable inappropriate-expression detection and readability evaluation within the data processing pipeline prevents the system from automatically converging to safe and clear text with minimal model invocations. Consequently, the computer system may perform redundant generative AI model calls and repeated user interactions, which degrade system throughput and responsiveness.

Third, existing approaches often fail to leverage accumulated communication history stored in a data storage device to dynamically update detection criteria for inappropriate expressions. The inappropriate-expression detection is typically based on static keyword lists or fixed rules. Such static configurations do not adapt to actual usage patterns, domain-specific terminology, or evolving communication policies. This limits the technical capability of the system to reduce false positives and false negatives over time and prevents the system from improving its harassment prevention performance as more data is collected in the storage device.

Fourth, instructions generated by conventional systems are frequently ambiguous from the viewpoint of the recipient, because existing solutions do not systematically derive structured guideline information, such as explicit targets, deadlines, specific work contents, and support contents, from the same internal data representations used in prompt generation and post-processing. The lack of structured guideline generation forces users to interpret or rewrite the output manually. From a computer-technical perspective, the system fails to transform input data into a more structured and machine-usable representation that could be consistently reused across different user interfaces and applications.

Accordingly, there is a need for an improved computer-implemented system that (i) generates prompt sentences embedding structured case and event information together with explicit constraint conditions for harassment prevention and clarity, (ii) automatically evaluates and refines generative AI outputs via inappropriate-expression detection and readability evaluation, (iii) adaptively updates detection criteria using accumulated communication history stored in a data storage device, and (iv) generates machine-structured guideline information that can be presented to the user to clarify instructions. Such a system would improve the functioning of the computer by reducing redundant interactions with the generative AI model, minimizing manual corrective operations, and optimizing internal data flows and storage usage for safe and understandable communication content.

The specific processing by the specific processing unit 290 of the data processing device 12 in Example 2 is realized by the following means.

The present invention provides a server comprising a processor and a data storage device, the processor being configured to acquire, from a terminal, information regarding an instruction or feedback to a managed person, to store the information in the data storage device, and to analyze case information and event information included in the information; to generate, based on the analyzed case information and event information, a structured prompt sentence for a generative AI model, the structured prompt sentence including constraint conditions relating to prevention of harassment and ease of understanding by a recipient; to input the structured prompt sentence to the generative AI model, to obtain a generated text corresponding to the case information and the event information, and to perform an inappropriate-expression detection process and a readability evaluation process on the generated text; to, when an inappropriate expression is detected or when the readability does not satisfy a predetermined criterion, generate an additional prompt sentence for correction and re-input the additional prompt sentence to the generative AI model so as to automatically regenerate or correct the generated text; to analyze past instruction and feedback history information stored in the data storage device and to update, in a learning manner, a set of prohibited expressions or a determination criterion used in the inappropriate-expression detection process; and to generate guideline information explicitly indicating a target to be achieved, a deadline, specific work contents, and support contents based on at least one of the case information, the event information, and the generated text, and to transmit at least one of the corrected generated text and the guideline information to the terminal for presentation. This enables the computing system to implement an integrated technical pipeline in which input data are transformed into structured prompt sentences, evaluated and iteratively refined generative AI outputs, and machine-structured guideline information, thereby reducing redundant generative AI invocations, decreasing manual post-editing operations, adaptively improving harassment detection accuracy using stored communication history, and enhancing overall processing efficiency and reliability of the server in generating safe and easily understandable communication content.

The term “processor” refers to a hardware computing element, such as a central processing unit or a programmable logic device, configured to execute machine-readable instructions to perform data acquisition, analysis, generation, evaluation, and control operations described in the present specification.

The term “terminal” refers to an electronic apparatus, such as a mobile communication device, a personal computer, or a workstation, that includes a user interface and a communication function and is configured to transmit information to and receive information from the server.

The term “information processing apparatus” refers to a hardware and software platform, including the processor and associated components, that executes programs to perform data processing operations such as communication control, data storage control, and interaction with a generative AI model.

The term “data storage device” refers to a non-transitory computer-readable medium, such as a magnetic storage device, a semiconductor memory device, or a solid-state drive, configured to store input information, generation results, history information, prohibited expression sets, and guideline information.

The term “managed person” refers to a member within an organization who receives instructions or feedback from a manager and to whom the generated instruction sentences, feedback sentences, or guideline information are directed.

The term “instruction or feedback information” refers to electronic data representing a manager's intention to provide operational directions, evaluations, or comments to a managed person, including free-text input and associated structured attributes such as project, issue type, and time period.

The term “case information” refers to data representing the context of a management situation, such as a project, task category, or organizational context, that is extracted or derived from the instruction or feedback information.

The term “event information” refers to data representing a specific occurrence or condition related to the case information, such as a delay, a quality issue, or a performance issue, including attributes such as affected phase and duration.

The term “prompt sentence” refers to a machine-generated sequence of characters or tokens that encodes instructions, context information, and constraint conditions to be provided as input to a generative AI model in order to control the model's output behavior.

The term “structured prompt sentence” refers to a prompt sentence that includes explicitly organized sections or fields, such as task description, context, requirements, and output specification, composed based on the analyzed case information and event information.

The term “generative AI model” refers to a machine-learned model implemented on a computing infrastructure, configured to generate natural language text or other content in response to an input prompt sentence by performing probabilistic inference over model parameters.

The term “optimized instruction sentence or feedback sentence” refers to a text output generated by the generative AI model and optionally post-processed by the system, which is tailored to the case information and event information and is constrained to be non-harassing, clear, and appropriate for the managed person.

The term “generation result” refers to data representing at least a portion of the output text produced by the generative AI model in response to a prompt sentence, including intermediate or final versions before or after correction.

The term “inappropriate-expression detection process” refers to a computer-implemented procedure that examines a generation result using one or more rules, models, or lexicons to determine whether the generation result contains expressions that are potentially harassing, offensive, discriminatory, or otherwise unsuitable.

The term “readability evaluation process” refers to a computer-implemented procedure that calculates one or more readability measures for a generation result, such as complexity level or ease of understanding, and determines whether the generation result satisfies at least one predetermined readability criterion.

The term “additional prompt sentence” refers to a second or subsequent prompt sentence generated based on a prior generation result and including instructions to correct or refine that generation result, the additional prompt sentence being re-input to the generative AI model.

The term “automatic regeneration or correction” refers to a process in which the processor, without requiring manual rewriting input from the user, causes the generative AI model to generate a revised text by supplying an additional prompt sentence constructed according to evaluation results.

The term “history information” refers to stored data representing past instructions, feedback, generation results, user approvals, and related metadata, which is accumulated in the data storage device over time.

The term “set of prohibited expressions” refers to a collection of data entries, such as words, phrases, patterns, or classification rules, that the inappropriate-expression detection process uses as criteria for determining that a portion of a generation result is inappropriate.

The term “determination criterion” refers to one or more threshold values, rules, model parameters, or decision conditions used by the inappropriate-expression detection process or the readability evaluation process to judge whether a generation result is acceptable.

The term “learning manner” refers to an automatic updating method in which the processor modifies the set of prohibited expressions or the determination criterion based on analysis of history information, so that detection behavior changes according to accumulated data.

The term “harassment prevention performance” refers to the capability of the system, as measured by its detection processes and generation control, to reduce the occurrence of harassing, offensive, or otherwise inappropriate expressions within generated communication content.

The term “guideline information” refers to structured electronic data derived from case information, event information, and generation results, the data explicitly indicating at least a target to be achieved, a deadline, specific work contents, and support contents for the managed person.

The term “target to be achieved” refers to an objective or desired outcome that the managed person is expected to reach, represented in the guideline information in a form that can be directly understood and acted upon.

The term “deadline” refers to a time-related constraint, such as a due date or completion time, by which the managed person is expected to achieve at least part of the target to be achieved.

The term “specific work contents” refers to concrete tasks, actions, or steps that the managed person is requested or required to perform, represented in the guideline information as explicit items.

The term “support contents” refers to information representing assistance, resources, or cooperation that may be provided by a manager or an organization to help the managed person execute the specific work contents and achieve the target to be achieved.

The term “presentation to the terminal” refers to the act of transmitting at least the corrected generated text or the guideline information from the server to the terminal and causing the terminal to display or otherwise output the information via a user interface.

In one embodiment, a server cooperates with one or more terminals operated by users to implement a communication assistance system for generating optimized instruction sentences and feedback sentences using a generative AI model.

The server includes a processor, a main memory, a network interface, and a data storage device. The server runs an operating system such as a general-purpose server operating system and executes application software implemented, for example, using a server-side framework in a programming language such as Python. The server is connected to a data storage device implemented by a relational database management system such as a general-purpose database engine running on magnetic storage or a solid-state drive.

The terminal includes a processor, a display, an input device such as a keyboard or touchscreen, a communication interface such as a wireless or wired network interface, and a local memory. The terminal executes a web browser such as a general-purpose browser, or a dedicated native application, and communicates with the server via a network such as the Internet or a local area network using a protocol such as HTTPS.

The user operates the terminal to access a web-based interface or an application interface provided by the server. The terminal displays an input screen that allows the user, acting for example as a manager, to input instruction or feedback information directed to a managed person. The instruction or feedback information includes both natural language text and structured attributes. The user can input, as free text, content such as: “The progress of Project X is delayed, especially in the design phase, by about two weeks.”

The user can also select structured attributes via drop-down menus or check boxes, such as project name, issue type (e.g., schedule delay), phase (e.g., design phase), and delay period (e.g., two weeks). The terminal transmits, via the network interface, this instruction or feedback information to the server in a structured format.

The server receives the instruction or feedback information and stores it in the data storage device. The server normalizes the data into internal records, for example by creating a record including fields for user identifier, managed person identifier, case information (such as project identifier and task category), event information (such as delay type, affected phase, and duration), and the original free-text content. The server assigns indexes to selected fields such as project identifier and timestamp to enable efficient retrieval and analysis across a large volume of history information.

The server analyzes the instruction or feedback information to derive case information and event information. The server uses deterministic parsing logic and, optionally, natural language processing tools such as a syntactic parser or named entity recognizer executing on the processor to identify entities such as project names and task phases from the text. The server maps the parsed entities to canonical codes stored in lookup tables in the data storage device. This mapping reduces ambiguity and allows subsequent processing steps to use compact, machine-friendly representations rather than raw text strings.

The server then constructs a structured internal representation of the communication context. For example, the server may generate a data structure with fields such as “project_name,” “issue_description,” “delay_period,” “original_manager_input,” and “desired_tone.” This internal representation is used as the basis for forming a prompt sentence to be supplied to the generative AI model. The server generates a prompt sentence that encodes, in a structured and constrained natural language format, the communication task, the case information, the event information, and explicit constraints related to harassment prevention and ease of understanding. In one embodiment, the server assembles the prompt sentence using a template stored in the data storage device. The template includes defined sections such as “Task,” “Context,” “Requirements,” and “Output,” and the server fills in variable fields based on the analyzed context.

For example, the server generates a prompt sentence such as:

“You are a communication assistant for managers.

Task:

Generate a feedback message from a manager to a subordinate about a project delay.

Context:
Project name: Project X
Issue: The design phase is delayed
Delay period: 2 weeks
Original manager input: ‘The progress of Project X is delayed, especially in the design phase, by about two weeks.’

Requirements:
Avoid any harassing, insulting, or discriminatory expressions.
Use clear, respectful, and professional language.
Make the message easy for the subordinate to understand.
Focus on facts and constructive next steps.

Output:

Provide one message of 3-5 sentences in English.”

In another example, when the user supplies an initial draft containing harsh wording, the server generates a prompt sentence such as:

“You are a communication assistant for managers.

Task:

Rewrite the following draft message so that it is firm but non-harassing, and easy for a subordinate to understand.

Manager's draft:

‘You are always late with your reports. This is unacceptable and shows a lack of responsibility.’

Requirements:
Remove any expression that could be considered harassment.
Keep the core message: repeated delays in reports are a serious issue.
Use neutral, fact-based language and suggest next steps.
Make it clear what behavior is expected in the future.

Output:

Return only the revised message in English.”

The server then transmits the generated prompt sentence to a generative AI model implemented on a remote or local computing infrastructure. In one embodiment, the generative AI model is a transformer-based neural network model trained for natural language generation. The model comprises an embedding layer, a plurality of self-attention layers, feed-forward layers, and a softmax output layer. The parameters of the model include weights and biases for each layer, which have been optimized during a training phase using a large corpus of example texts.

In training, the model is configured to minimize a loss function, such as cross-entropy loss between predicted tokens and ground truth tokens, using an optimization algorithm such as stochastic gradient descent or a variant thereof. During training, the model updates its weights by backpropagation, propagating prediction errors from the output layer back through the attention and feed-forward layers, and adjusting parameters to reduce future errors. Training data may be augmented using standard data augmentation techniques, such as paraphrasing or random masking of tokens, to increase robustness against variations in input style. The trained model is then used in inference mode within the system.

During inference, the server tokenizes the prompt sentence into a sequence of tokens using a tokenizer consistent with the generative AI model's vocabulary. The server sends the tokenized prompt and inference parameters (such as temperature, maximum token length, and decoding strategy) to the generative AI model through an application programming interface. The generative AI model processes the tokens by performing multi-head self-attention and feed-forward computations across multiple layers and outputs a sequence of probability distributions over the vocabulary for each position. The model then selects output tokens according to a decoding algorithm such as greedy decoding or top-k sampling, thereby producing an output text sequence.

The server receives the output text as a generation result and stores the generation result in the data storage device in association with the original input and the internal context representation. The server then executes an inappropriate-expression detection process on the generation result. In one embodiment, the server uses a hybrid approach combining a rule-based filter and a learned classifier. The rule-based filter uses a set of prohibited expressions stored in the data storage device, including words, phrases, and regular expression patterns that correspond to potentially harassing or offensive language. The server scans the generation result for occurrences of these expressions and flags segments that match the criteria.

In addition, the server optionally applies a simple classification model, such as a logistic regression classifier or a small neural network, that uses features derived from the generation result, such as token n-grams, sentiment scores, and parts-of-speech distributions, to estimate a probability that the text is inappropriate. The server compares the estimated probability against a determination criterion stored in the data storage device. The server concludes that the generation result is inappropriate if either the rule-based filter finds a prohibited expression or the classifier's probability exceeds the threshold. The server records the detection outcome in the data storage device.

The server also executes a readability evaluation process on the generation result. The server computes readability metrics such as sentence length, word length, and vocabulary difficulty using algorithms like Flesch-Kincaid or similar formulas implemented in software. The server may also compute additional indices tailored to the organization, such as the relative frequency of technical terms versus common words. The server compares calculated readability scores against one or more predetermined criteria stored in the data storage device. If the readability is lower than a required level or higher than a maximum level (for example, too complex), the server determines that the generation result does not satisfy readability requirements.

When the inappropriate-expression detection process or the readability evaluation process indicates that the generation result is unsatisfactory, the server generates an additional prompt sentence to request a corrected or improved version of the text from the generative AI model.

The server constructs this additional prompt sentence using a specialized template that references the previous generation result and explicitly states the deficiencies. For example, the server may generate an additional prompt sentence such as:

]The previous message may contain expressions that are too harsh or difficult to understand.

Task:

Rewrite the following message so that:
The tone is neutral, respectful, and supportive.
There are no blaming or harassing expressions.
The instructions remain specific and easy to understand.

Original message:

‘I am not satisfied with your work at all, and your delay is unacceptable.’

Output:

Return only the revised message in English.”

The server sends the additional prompt sentence to the generative AI model, obtains a corrected generation result, and repeats the evaluation steps until the inappropriate-expression detection process and the readability evaluation process both indicate that the generation result satisfies the criteria or until a configured iteration limit is reached. This automated refinement loop enables the server to converge toward safe and comprehensible texts while reducing the need for repeated manual editing by the user.

The server further analyzes accumulated history information stored in the data storage device to update the set of prohibited expressions and determination criteria. The server periodically or on demand executes a learning process that scans stored generation results, user approvals or rejections, and manual edits to identify patterns of phrases that users frequently modify or reject as inappropriate. The server applies clustering or frequency analysis to these phrases and proposes new prohibited expressions or modifications to thresholds. The server may optionally rely on a small supervised learning model that predicts user rejection based on textual features. When the model detects systematic patterns associated with rejected content, the server updates the set of prohibited expressions or the determination criteria accordingly.

This learning-based update mechanism enables the system to adapt to evolving organizational policies and domain-specific usage, thereby improving harassment prevention performance over time.

The server also generates guideline information intended to make instructions more concrete and operational for the managed person. Based on the case information, the event information, and the final accepted generation result, the server extracts elements such as the target to be achieved, deadline, specific work contents, and support contents. The server applies rule-based extraction and pattern recognition to identify phrases that describe goals (for example, “bring the schedule back on track”), time constraints (for example, “by the end of next week”), tasks (for example, “prepare a weekly progress report”), and offers of support (for example, “let me know if you need any assistance”). The server structures these elements into a guideline data structure with clearly labeled fields. The server then composes a guideline presentation, which may be displayed as bullet points or structured sections on the terminal.

For example, the server may cause the following guideline information to be displayed:

“Target:
Recover the schedule of Project X so that the design phase is back on track.

Deadline:
Agree on corrective actions by the end of this week. Specific work contents:
Identify the main reasons for the two-week delay.
Propose specific countermeasures for each reason.
Prepare a short report summarizing the plan.

Support contents:
The manager will review proposed countermeasures and help coordinate resources if needed.”

The terminal displays the final generation result and the guideline information on its display.

The user reviews the optimized instruction or feedback sentence and the associated guideline information, and can edit or approve the text via input operations on the terminal. When the user approves the content, the terminal notifies the server, and the server stores the approved text and guideline information as finalized communication records. The user may then transmit the approved message to the managed person through email, a messaging system, or another communication channel. In some variations, the server may integrate with external communication systems to send the approved message automatically.

From a technical perspective, this system improves computer technology in several ways. By generating structured prompt sentences that explicitly encode context and constraints, the server provides the generative AI model with more informative and regularized inputs than ad hoc free-text prompts. This reduces variance in the model's outputs and decreases the number of trial-and-error model calls, thereby reducing network traffic and computation time on the generative AI infrastructure. Because the prompt sentences follow a consistent internal format, the server can reuse common templates and caching strategies, further reducing computational load.

By integrating the inappropriate-expression detection process and readability evaluation process as machine-executable steps in the processing pipeline, the server avoids leaving quality control entirely to human users. The automatic refinement loop acts as a pre-filter that prevents low-quality or risky outputs from being presented as final results. This reduces the number of manual corrections and approvals needed, shortens response times, and increases throughput when many requests are processed simultaneously. The internal evaluation processes also allow the server to assign scores to generation results and track system performance over time.

By updating the set of prohibited expressions and determination criteria based on accumulated history information, the server leverages the data storage device not only as passive storage but as an active source of feedback that improves the detection algorithms.

This adaptive mechanism allows the inappropriate-expression detection process to reflect actual user preferences and real-world language use. As a result, false positives and false negatives are reduced, and the system can maintain high accuracy even as vocabulary and communication styles change. This is not merely automating human review; it changes the underlying detection model in a way that is difficult to achieve through manual rule maintenance alone.

By generating structured guideline information aligned with the final instruction or feedback sentences, the server produces machine-usable representations of communication goals and tasks. This structured representation can be used by other software modules, such as workflow management or scheduling systems, thereby enabling further automation and integration. The conversion from unstructured natural language to structured guideline fields is performed using specific extraction rules and pattern recognition algorithms, improving the utility of the stored data beyond simple text storage.

In alternative embodiments, the server may use different generative AI model architectures, such as encoder-decoder transformers or recurrent neural networks, provided that the model accepts a prompt sentence as input and generates natural language text as output. The server may also employ different learning algorithms for updating prohibited expressions, such as reinforcement learning based on user feedback, or semi-supervised clustering of rejected phrases.

In another embodiment, the terminal may be implemented as a dedicated application that performs some local preprocessing, such as offline language checking or local caching of recently used instructions. The server may, in yet another embodiment, distribute components of the inappropriate-expression detection process across multiple processing nodes to increase scalability. Variations in network protocol, storage engine, and hardware configuration can be adopted without departing from the essential data flow in which the server acquires instruction or feedback information, generates and refines prompt sentences and generation results using a generative AI model, evaluates those results according to explicit criteria, and outputs final optimized communication content and guideline information to the terminal.

Through these configurations, the server, the terminal, and the generative AI model cooperate to form a technical system that not only automates text creation but also improves the efficiency, reliability, and adaptability of computer-based communication processing, thereby providing concrete enhancements to computer technology itself.

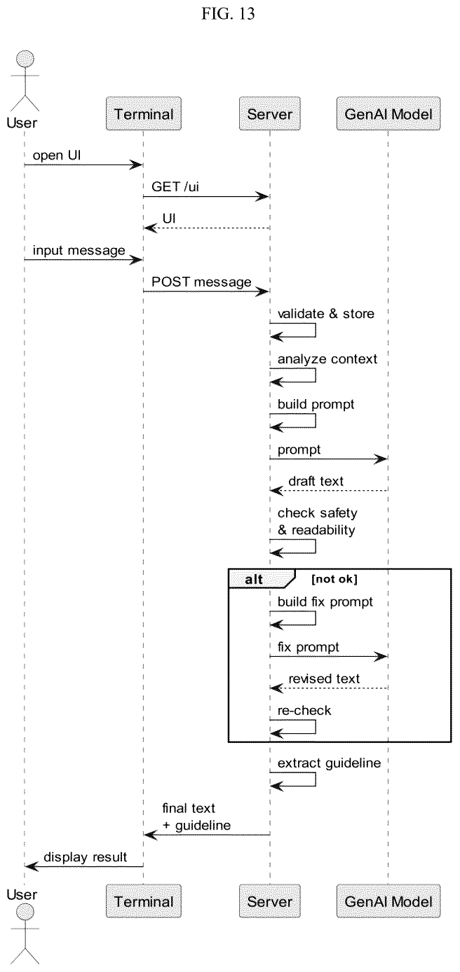

The following describes the processing flow using FIG. 13.

### Step 1

The user operates the terminal to access the server.

The terminal sends an access request to the server and receives interface data such as an input screen layout. The input of this step is a user action (access request), and the output is an interactive screen displayed on the terminal, including fields for entering instruction or feedback information and related attributes.

### Step 2

The user inputs instruction or feedback information for a managed person on the terminal.

The terminal captures text input (for example, “The progress of Project X is delayed, especially in the design phase, by about two weeks.”) and structured selections (for example, project name, issue type, phase, and delay period). The input of this step is the user's keystrokes and selections, and the output is a structured data object stored in the terminal's memory that represents the instruction or feedback information.

### Step 3

The terminal transmits the structured instruction or feedback information to the server.

The terminal packages the data object into a request message and sends it via a communication protocol to an interface of the server. The input of this step is the structured data object in the terminal, and the output is a corresponding data payload received by the server's communication module.

### Step 4

The server receives and validates the instruction or feedback information.

The server parses the received payload, checks required fields (for example, presence of text, valid issue type, maximum length), and rejects or accepts the data according to predetermined rules. The input of this step is the raw payload from the terminal, and the output is either an error response (if validation fails) or a normalized internal representation of the instruction or feedback information (if validation succeeds).

### Step 5

The server stores the validated instruction or feedback information in a data storage device.

The server converts the internal representation into one or more database records and performs write operations, assigning identifiers and timestamps. The input of this step is the normalized internal representation, and the output is a persistent record stored in the data storage device, retrievable by identifiers and indexes.

### Step 6

The server analyzes the stored information to extract case information and event information.

The server reads relevant fields from the stored record and applies parsing logic and, optionally, language analysis to map free-text elements to canonical codes and structured descriptors. The input of this step is the stored record, and the output is a refined data structure containing explicit case information (such as project context) and event information (such as delay details and affected phase).

### Step 7

The server constructs an internal context representation for prompt generation.

The server aggregates case information, event information, and the original text into a single context object with labeled fields used for downstream processing. The input of this step is the refined case and event information plus the original text, and the output is a unified context representation that defines all variables needed to build a prompt sentence.

### Step 8

The server generates a structured prompt sentence for a generative AI model.

The server applies a prompt template and fills in sections such as “Task,” “Context,” “Requirements,” and “Output” with values from the context representation, including explicit constraints for harassment prevention and readability. The input of this step is the unified context representation, and the output is a complete prompt sentence expressed in natural language and structured according to the template.

### Step 9

The server sends the prompt sentence to the generative AI model and requests generation.

The server tokenizes the prompt, applies model parameters such as temperature and maximum length, and transmits the tokenized prompt to the generative AI model via an interface. The input of this step is the prompt sentence string, and the output is a set of model input tokens and configuration parameters delivered to the generative AI model.

### Step 10

The server receives a generation result from the generative AI model.

The server obtains the output tokens from the generative AI model, decodes them into a natural language text, and associates the resulting text with the original request. The input of this step is the model output tokens, and the output is a generation result text representing an optimized instruction sentence or feedback sentence.

### Step 11

The server stores the generation result in the data storage device.

The server appends the generation result to the existing record or creates a linked record that references the original instruction or feedback information and the context representation. The input of this step is the generation result text, and the output is a persistent association between the input data and the generated text stored in the data storage device.

### Step 12

The server executes an inappropriate-expression detection process on the generation result.

The server compares words and phrases in the generation result against a set of prohibited expressions and applies additional classification rules or models to detect potentially harassing or offensive content. The input of this step is the generation result text and the current detection rules, and the output is a detection outcome indicating whether inappropriate expressions are present and, if so, their locations within the text.

### Step 13

The server executes a readability evaluation process on the generation result.

The server calculates readability metrics such as sentence length and vocabulary complexity and compares them to predetermined criteria to determine whether the text is suitably understandable. The input of this step is the generation result text and stored readability criteria, and the output is a readability score together with a judgement indicating whether the text satisfies the required readability level.

### Step 14

The server determines whether the generation result satisfies both appropriateness and readability criteria.

The server evaluates the outputs of the inappropriate-expression detection and readability evaluation, and decides if the generation result is acceptable or requires refinement. The input of this step is the detection outcome and the readability judgement, and the output is a decision flag indicating either acceptance or a need for correction and regeneration.

### Step 15

The server generates an additional prompt sentence when correction is required.

When the decision flag indicates that the generation result is unsatisfactory, the server builds an additional prompt sentence that includes the previous generation result, specifies detected issues, and instructs the generative AI model to rewrite or refine the text. The input of this step is the unsatisfactory generation result and the evaluation details, and the output is a corrective prompt sentence designed to direct the generative AI model toward safer and clearer output.

### Step 16

The server sends the additional prompt sentence to the generative AI model and obtains a corrected generation result.

The server repeats the tokenization and model invocation procedure using the corrective prompt and receives a new output text, then decodes it into natural language. The input of this step is the corrective prompt sentence, and the output is a corrected generation result text intended to address the previously detected issues.

### Step 17

The server iterates evaluation and correction until an acceptable generation result is obtained or an iteration limit is reached.

The server applies the same inappropriate-expression detection and readability evaluation to each corrected generation result and decides whether further correction is necessary, repeating the loop as needed. The input of this step is each successive generation result, and the output is either a final accepted generation result or a last available result when a predetermined iteration limit is reached.

### Step 18

The server analyzes history information to update prohibited expressions and determination criteria.

The server processes stored records of past generation results, user approvals, and user rejections to identify phrases and patterns correlated with negative user feedback, then adjusts the set of prohibited expressions and thresholds used in detection. The input of this step is accumulated history information and associated user responses, and the output is an updated detection configuration that refines future inappropriate-expression and readability evaluations.

### Step 19

The server derives guideline information from the accepted generation result and context.

The server applies extraction rules to identify elements such as targets, deadlines, work contents, and support contents from the combination of the accepted text and stored context, and then structures these elements into a guideline data object. The input of this step is the accepted generation result and the context representation, and the output is guideline information with clearly labeled fields suitable for presentation.

### Step 20

The server transmits the accepted generation result and guideline information to the terminal.

The server packages the optimized instruction or feedback sentence and the structured guideline data into a response message and sends it to the terminal via the communication interface. The input of this step is the final accepted text and guideline information, and the output is a response payload received by the terminal for display.

### Step 21

The terminal displays the accepted generation result and guideline information to the user.

The terminal renders the text message and structured guideline elements on its display, allowing the user to read and understand the recommended communication and associated actions. The input of this step is the response payload from the server, and the output is a visual presentation on the terminal's screen, which becomes the basis for user review and optional further actions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In collaborative work environments, a computing system often assists a manager in drafting instructions or feedback for a subordinate. However, conventional systems that simply generate or template text from a single input string suffer from several technical limitations.

First, a conventional text generation system typically treats an input sentence as an isolated sequence of characters or tokens and does not robustly integrate heterogeneous contextual data such as structured attribute information of the subordinate, detailed task and situation information, and dynamically estimated emotional state of the user. As a result, the generative component cannot effectively condition its output on user-specific and subordinate-specific context, and the system must either ignore such context or handle it in a separate, manual step. This leads to redundant network calls, fragmented data flows, and inefficient utilization of computational resources.

Second, a conventional system generally calls a generative AI model with a static or hand-crafted prompt string that is not adaptively updated based on past performance or user feedback. The system does not maintain a feedback loop that analyzes reaction text, evaluation data, or emotional responses to previously generated expressions. Consequently, the system cannot automatically refine its prompt construction logic, its mapping between attribute information and expression styles, or its post-processing rules. This absence of adaptive prompt engineering forces human operators to tune prompts manually and prevents the system from improving over time in a data-driven manner.

Third, existing systems often lack an integrated pipeline that performs (i) linguistic analysis of the user's natural language input, (ii) emotion analysis using a dedicated emotion analysis device or program, (iii) structured prompt sentence construction, (iv) controlled generation of candidate expressions by a generative AI model, and (v) multi-stage post-processing that enforces guideline conformity and removes inappropriate expressions. Instead, these operations, if present, are typically implemented as decoupled modules with ad-hoc interfaces, resulting in increased latency, duplicated parsing operations, inconsistent policy enforcement, and higher complexity in error handling.

Fourth, conventional systems do not systematically link text-based assistance with audio output in a unified architecture. When speech synthesis is provided, it is usually invoked as an external, loosely coupled component that is unaware of the underlying profile information or emotion context. This causes the system to perform redundant formatting or conversion steps and offers no mechanism to align the generated audio with dynamically updated expression styles or harassment-prevention rules.

Fifth, existing approaches that attempt to filter or monitor harassment or inappropriate expressions usually operate only on final text outputs or communication logs and do not integrate such detection into the same processing path that constructs prompts and performs generation. As a result, inappropriate expressions may be generated and then rejected or edited later, incurring wasted computation and additional round trips, and making it difficult to guarantee compliance at the time of generation.

Accordingly, there is a need for an improved computer-implemented system and server architecture that (1) acquires and unifies natural language input, subordinate attribute information, and emotion information into structured profile information; (2) automatically generates and maintains a context-rich prompt sentence for a generative AI model; (3) enforces post-processing rules for harassment prevention, guideline conformity, and format adjustment as part of a single integrated pipeline; and (4) uses feedback data, including reaction text and emotional responses, to adaptively update prompt generation rules, style mappings, and post-processing conditions. Such a system should reduce redundant processing, improve the quality and stability of generated expressions, and provide a more efficient and reliable computing mechanism for generating context-appropriate proposed expressions and corresponding audio data.

The specific processing by the specific processing unit 290 of the data processing device 12 in Application Example 2 is realized by the following means.

The present invention provides a server comprising a processor configured to (i) acquire, from a user terminal, natural language text data relating to an instruction or feedback for a subordinate and attribute information of the subordinate as input data, perform language analysis processing on the natural language text data to extract structured information including at least task content, situation, emotional expression, and type of intent, and associate the attribute information of the subordinate with the structured information and store the associated information as profile information; (ii) generate, by using the structured information, the profile information, and emotion information of a user estimated from the natural language text data by an emotion analysis device or an emotion analysis program, a prompt sentence that explicitly defines conditions for generating an expression to be provided to the subordinate, input the prompt sentence into a generative AI model, and cause the generative AI model to generate a candidate expression reflecting at least the subordinate's attributes, a work situation, and an emotional state of the user; (iii) perform post-processing including at least inappropriate expression detection processing, guideline conformity determination processing, and format adjustment processing on the candidate expression output from the generative AI model, adjust the candidate expression from viewpoints of preventing harassment, improving ease of understanding, and improving acceptance, determine a final proposed expression, and output the proposed expression to the user terminal; (iv) accumulate, as feedback data, reaction text, evaluation information, or emotion information regarding the proposed expression acquired from the user terminal or a subordinate terminal, and update at least a generation rule for the prompt sentence, a correspondence relationship between the attribute information and an expression style, and a determination condition used in the post-processing in accordance with the feedback data so as to adaptively improve content and tone of the proposed expression subsequently generated; and (v) when generation of audio data corresponding to the proposed expression is required, input the proposed expression into a speech synthesis device or a speech synthesis program to generate the audio data and output the audio data to a worker terminal. This enables the computer system to implement an integrated and adaptive processing pipeline in which contextual data and emotion information are fused into a structured prompt sentence for a generative AI model, in which candidate expressions are automatically filtered and normalized according to harassment-prevention and guideline rules, and in which feedback-driven updates to prompt generation logic and post-processing conditions continually improve the efficiency, robustness, and quality of generated text and audio outputs.

The term “user terminal” refers to an information processing apparatus operated by a user, such as a manager or supervisor, that includes at least an input unit and a display unit and transmits and receives data to and from a server over a communication network.

The term “subordinate terminal” refers to an information processing apparatus operated by a subordinate or worker that receives, displays, or outputs instructions or feedback generated by a server and transmits reaction or feedback data to the server.

The term “worker terminal” refers to an information processing apparatus located at a work site and configured to output audio data or display text data representing instructions or feedback generated by a server to a worker.

The term “processor” refers to a hardware processing unit, such as a central processing unit or a graphics processing unit, or a combination thereof, that executes instructions of a program to perform data acquisition, analysis, generation, and control operations.

The term “natural language text data” refers to character string data representing human-readable sentences in a natural language, such as instructions, feedback, or reactions, which are input by a user or generated by a system.

The term “attribute information” refers to structured data describing characteristics of a subordinate or worker, including at least an age group, a gender, a role, work experience, and other profile-related attributes.

The term “profile information” refers to data in which attribute information of a subordinate or worker is associated with structured information derived from natural language text data, the profile information being stored and used as context for generating expressions.

The term “language analysis processing” refers to a series of operations that analyze natural language text data, including at least tokenization, part-of-speech tagging, syntactic parsing, and extraction of elements such as task content, situation, emotional expression, and type of intent.

The term “structured information” refers to information obtained by converting natural language text data into a machine-processable format that includes identified items such as task content, situation, emotional expression, and type of intent, represented as fields or key-value pairs.

The term “task content” refers to information indicating a work item, duty, or operation to be performed by a subordinate or worker, which is extracted from natural language text data.

The term “situation” refers to information indicating a contextual state related to task content, such as a delay, progress, environment, or condition of execution, which is extracted from natural language text data.

The term “emotional expression” refers to linguistic elements in natural language text data that indicate or imply a psychological state of a speaker or writer, such as concern, frustration, or satisfaction.

The term “type of intent” refers to a classification indicating whether natural language text data represents, for example, an instruction, feedback, a request, a question, or another communicative function.

The term “emotion analysis device” refers to a hardware and software configuration that receives text, audio, or video data and outputs information indicating an estimated emotional state associated with the data.

The term “emotion analysis program” refers to software that analyzes natural language text data or media data to estimate an emotional state, using techniques such as sentiment analysis, tone analysis, or affective computing.

The term “emotion information” refers to data representing an estimated emotional state of a user or subordinate, including types of emotions and optionally intensity values, which is output by an emotion analysis device or an emotion analysis program.

The term “prompt sentence” refers to a text string provided as input to a generative AI model, the text string explicitly defining conditions, constraints, and context for generating an expression for a subordinate or worker.

The term “generative AI model” refers to a machine learning model that, in response to a prompt sentence, generates natural language text by performing probabilistic or neural-network-based inference.

The term “candidate expression” refers to natural language text generated by a generative AI model based on a prompt sentence, before being subjected to post-processing by a processor.

The term “proposed expression” refers to a natural language text that is obtained by applying post-processing to a candidate expression and is intended to be output to a user terminal or worker terminal as a final suggestion.

The term “expression style” refers to characteristics of wording, such as formality level, directness, politeness, and motivational tone, used in an expression for a subordinate or worker.

The term “post-processing” refers to processing applied to a candidate expression generated by a generative AI model, including at least inappropriate expression detection, guideline conformity determination, and format adjustment.

The term “inappropriate expression detection processing” refers to processing that analyzes an expression to detect language that may correspond to harassment, discrimination, or other undesirable or restricted content according to predetermined rules or models.

The term “guideline conformity determination processing” refers to processing that determines whether a candidate expression complies with predetermined communication guidelines, such as clarity requirements, politeness standards, or regulatory constraints.

The term “format adjustment processing” refers to processing that modifies a candidate expression in terms of formatting, such as punctuation, layout, or segmentation, without changing a substantive meaning, to improve readability or output compatibility.

The term “feedback data” refers to data that includes at least reaction text, evaluation information, or emotion information regarding a proposed expression, the data being collected from a user terminal or subordinate terminal for adaptive improvement.

The term “reaction text” refers to natural language text expressing a response, impression, or comment by a user or subordinate with respect to a proposed expression.

The term “evaluation information” refers to structured data representing an evaluation of a proposed expression, such as a rating, preference indicator, or selection result.

The term “generation rule for the prompt sentence” refers to a set of conditions, templates, or algorithms that define how structured information, profile information, and emotion information are combined to construct a prompt sentence for a generative AI model.

The term “correspondence relationship between the attribute information and an expression style” refers to a mapping that associates specific attribute values of a subordinate, such as age group or role, with preferred ranges of expression styles, such as formality or directness.

The term “determination condition used in the post-processing” refers to one or more thresholds, rules, or criteria employed to judge whether a candidate expression should be modified, filtered, or accepted during post-processing.

The term “speech synthesis device” refers to a hardware and software system configured to convert text data into audio data representing speech, based on a speech synthesis algorithm.

The term “speech synthesis program” refers to software that receives text as input and generates corresponding audio data by executing a speech synthesis algorithm.

The term “audio data” refers to digital information representing sound waves, including synthesized speech derived from a proposed expression, which is output to a worker terminal or subordinate terminal.

The term “monitoring target data” refers to data subjected to inappropriate expression detection, including at least natural language text data input by a user and candidate expressions or proposed expressions output by a generative AI model.

The term “harassment” refers to a category of inappropriate behavior or expression, including language that may cause discomfort, discrimination, or a hostile environment for a subordinate or worker, as defined by predetermined rules or policies.

The term “work environment” refers to conditions in which a subordinate or worker performs tasks, including psychological atmosphere affected by communication content generated or supported by a system.

The term “instruction clarification guide information” refers to auxiliary information that includes at least explanation elements, important points, recommended expression examples, and prohibited expression examples, and that assists a manager in formulating clear and understandable instructions.

The term “explanation elements” refers to constituent parts of an instruction that provide necessary context, reasons, or additional details to facilitate understanding by a subordinate.

The term “important points” refers to key items or focal aspects of an instruction that a subordinate should especially pay attention to when executing a task.

The term “recommended expression examples” refers to sample sentences that illustrate desirable wording patterns guided by predetermined communication policies.

The term “prohibited expression examples” refers to sample sentences that illustrate undesirable or restricted wording patterns that should be avoided in generated or manually composed expressions.

The term “clarity” refers to a property of an expression indicating that a subordinate can easily grasp the content, intent, and required actions without ambiguity.

The term “ease of understanding” refers to a property of an expression indicating that a subordinate can interpret the expression correctly and efficiently, considering linguistic complexity and contextual support.

The term “acceptance” refers to a degree to which a subordinate is likely to receive and mentally accept an instruction or feedback without unnecessary resistance, based on wording, tone, and context.

The term “work situation” refers to a state or condition associated with a task or project, including temporal progress, delays, workload, and other operational factors.

The term “user” refers to an individual, such as a manager or supervisor, who operates a user terminal to input instructions or feedback and receive proposed expressions generated by a server.

The term “subordinate” refers to an individual who receives instructions or feedback from a user and whose attribute information and reactions are used by a system to generate or adjust expressions.

The term “worker” refers to an individual performing tasks at a work site and receiving audio or textual instructions or feedback via a worker terminal or subordinate terminal.

In one embodiment, a server, one or more terminals, and a communication network cooperate to implement the claimed system. The server includes at least one processor and a memory storing programs and data structures. The processor executes the programs to carry out language analysis, emotion analysis, prompt sentence construction, generative AI model invocation, post-processing, adaptive feedback learning, and speech synthesis control. The terminals include a user terminal operated by a manager or supervisor, and optionally a subordinate terminal or worker terminal located at a work site. The terminals each include an input device, a display device, and, in some embodiments, a microphone and a speaker.

The server uses general-purpose hardware such as a multi-core central processing unit and, in some embodiments, one or more graphics processing units. The server executes system software such as an operating system, a network stack, and middleware, as well as application software implemented, for example, in a high-level programming language running with a web framework. The server may use a deep learning framework such as a tensor computation library or a neural network library to execute a generative AI model and an emotion analysis model on the graphics processing unit. The server uses a database management system, for example a relational database, to store profile information, structured information, feedback data, and configuration parameters for prompt sentence generation and post-processing.

The server maintains specific data structures to support the claimed functions. The server stores subordinate attribute information as records in a profile table, where each record includes a subordinate identifier, an age group field, a gender field, a role field, an experience years field, and optional custom flags that indicate communication preferences. The server stores natural language text data received from the user terminal as records in a communication table. Each communication record includes a communication identifier, a user identifier, a subordinate identifier, a raw text field, and a timestamp. The server stores structured information obtained by language analysis as a structured field associated with the communication record, for example in a key-value format or a nested object including explicit keys for task content, situation, emotional expression, and type of intent.

The server executes a language analysis program configured to transform raw natural language text into structured information. The server uses a tokenizer to split the text into tokens, a part-of-speech tagger to assign grammatical tags, and a dependency parser to build a dependency tree. The server then maps the parsed elements into the structured information data structure by applying rule-based patterns and statistical classifiers. For example, the server may detect that a phrase such as “the assembly of part A is delayed” should be mapped to task content “assembly of part A” and situation “delay,” and that the overall sentence type corresponds to an instruction intent. By storing this structured information in a normalized format, the server allows subsequent modules to operate on typed fields instead of unstructured text, which reduces repeated parsing and improves computational efficiency.

The server executes an emotion analysis program implemented, for instance, as a neural network classifier trained on labeled text and audio data. The server provides as input to this classifier one or more feature vectors computed from the natural language text data, such as token embeddings, sentence embeddings, and prosodic features (if audio is provided). The emotion analysis classifier may be a transformer-based neural network with multiple attention layers and feed-forward layers trained to output discrete emotion labels (e.g., concern, frustration, neutrality) and corresponding confidence scores. The server applies this classifier to the user's input to generate emotion information representing an estimated emotional state. The server stores the emotion information as part of the communication record and also uses it as an input feature for the subsequent prompt sentence generation.

The server constructs a prompt sentence as a dedicated data object for controlling the generative AI model. The prompt sentence includes textual segments encoding (1) the structured information (task content, situation, type of intent), (2) the profile information of the subordinate, and (3) the emotion information of the user. The server uses a prompt template that includes placeholders for these segments and generates a concrete prompt sentence by filling the placeholders with values from the structured information and profile information records. For instance, the server may generate a prompt sentence such as:

“Work content: assembly of part A.

Situation: delay.

Subordinate profile: age group 20s, male, factory worker, 3 years of experience.

Manager emotion: concern and slight frustration.

Task: Generate a clear, respectful instruction sentence from the manager to the subordinate that explains the delay, asks for efficiency improvement, and avoids any harassing or offensive tone.”

By structuring the prompt sentence in this way, the server ensures that the generative AI model receives all relevant contextual information in a consistent and machine-processable format. This reduces the need for multiple separate model calls and avoids context loss that would occur if the components processed data independently.

The server implements the generative AI model as a trained neural network that receives the prompt sentence as input and outputs a candidate expression as text. In one embodiment, the generative AI model is a transformer-based language model with multiple attention heads, residual connections, and layer normalization. The model is trained on a large corpus of text using a next-token prediction objective. During deployment, the server encodes the prompt sentence as token identifiers, passes the token sequence through embedding layers, stacked attention blocks, and feed-forward networks, and then decodes the predicted tokens to text representing the candidate expression. The server controls model parameters such as temperature, top-k, and maximum token length to adjust variability and ensure that generated outputs match the system's constraints.

The server differentiates the present system from a mere automation of human drafting by integrating the generative AI model with structured profile information, emotion information, and adaptive feedback. The server does not simply replace human writing with a machine; instead, the server implements a technical improvement in how contextual and emotional information is encoded, transmitted, and used within a data processing pipeline. The prompt sentence is not a generic natural language hint but a carefully constructed control signal that leverages the specific data structures and mappings maintained by the server. By optimizing this control signal algorithmically, the server reduces redundant computation and network calls and improves the stability of generated outputs across different contexts.

The server performs post-processing on the candidate expression generated by the generative AI model to ensure that the final proposed expression complies with constraints on harassment prevention, clarity, and acceptance. The server implements an inappropriate expression detection module that operates on the candidate expression using a combination of rule-based filters and trained classifiers. For example, the server may apply a lexical filter that checks for banned terms or patterns, and a classification model that predicts whether the tone of the candidate expression is excessively aggressive or derogatory given the subordinate profile. The server applies guideline conformity determination processing by comparing the candidate expression to stored communication guidelines that specify required elements (such as inclusion of reasons, reference to shared goals, or explicit offers of support) and prohibited constructions (such as direct personal attacks). The server adjusts the candidate expression where necessary by rephrasing or removing segments, using deterministic transformations or additional constrained calls to the generative model under stricter templates.

The server carries out format adjustment processing on the candidate expression to normalize punctuation, capitalization, and line breaks. The server may split long sentences into shorter units to improve readability on the terminal display and may add markers to separate introduction, main instruction, and closing remark. By applying these post-processing steps systematically, the server produces a proposed expression with reduced variance and more predictable structure, enabling easier analysis and future reuse.

The server outputs the proposed expression to the user terminal as part of a response message over the communication network. The user terminal displays the proposed expression on a graphical user interface. The user reads the expression and may adopt it as is or modify it manually. The same architecture allows the subordinate terminal or worker terminal to display the proposed expression or a simplified version. Where required, the server generates corresponding audio data by providing the proposed expression to a speech synthesis program. The speech synthesis program converts the text into audio waveforms using a parametric or neural text-to-speech model. The server then streams the audio data to the worker terminal, which plays the instruction through its speaker. This operation shows that the system is not confined to abstract data manipulation but directly controls the behavior of output devices in a physical environment by producing machine-interpretable audio signals that direct human operators at a work site.

The server implements an adaptive feedback mechanism that updates its internal configuration based on feedback data. The server acquires reaction text, evaluation information, and emotion information regarding the proposed expression from the user terminal or subordinate terminal. The server stores these feedback data in a feedback table, linking each feedback record to the corresponding proposed expression, subordinate profile, and prompt sentence. The server analyzes the distribution of feedback outcomes across different profile segments and expression styles using statistical aggregation and clustering methods. For example, the server can detect that subordinates in a particular age group consistently rate very formal expressions as unsatisfactory. The server then updates the correspondence relationship between attribute information and expression styles by adjusting a mapping table that influences prompt sentence construction.

The server updates generation rules for the prompt sentence by modifying parameters in the prompt template generation logic. For instance, if feedback indicates that expressions without a clear explanation of the reason for an instruction are poorly received, the server increases a weight associated with the inclusion of “reason” segments in the prompt sentence. The server also updates determination conditions used in post-processing, such as thresholds for the classifier's confidence when deciding whether to flag an expression as potentially harassing.

These updates may be applied periodically or continuously, depending on the implementation.

The server thereby improves computing efficiency and accuracy over time. Because the server maintains and refines mappings and rules based on feedback data, later generations require fewer manual edits by users, which reduces unnecessary re-computation and data transfer. In addition, the server achieves improved precision in harassment detection and guideline conformity by learning from actual usage data. From a system perspective, these adaptations represent changes to the internal operation of the server that were not possible in a static, rule-based approach; the server automatically reconfigures prompt generation and post-processing modules instead of relying on human tuning.

In another embodiment, the server incorporates multimodal emotion analysis. The server receives audio and video data from a terminal and extracts acoustic and visual features. The server computes features such as pitch contour, energy, speaking rate, and spectral coefficients from the audio data, and facial landmarks and expression vectors from video frames. The server combines these features into a feature vector for a multimodal neural network that outputs emotion information for the subordinate or worker. The server then uses this emotion information as an additional input to the prompt sentence and as a factor in choosing expression styles, such as whether to soften instructions when a worker appears fatigued.

The server can be implemented in several alternative configurations. In a first configuration, the server executes all core components (language analysis, emotion analysis, generative AI model, post-processing, feedback learning, speech synthesis control) on a single physical machine. In a second configuration, the system distributes the generative AI model and emotion analysis to specialized accelerator nodes connected via a high-speed network, and the main server orchestrates calls to these nodes. In a third configuration, the server delegates the generative AI model and speech synthesis to external service endpoints and maintains local control over prompt sentence generation, post-processing, and feedback learning. In each configuration, the claimed technical improvements—structured integration of profile information and emotion information, context-rich prompt sentence generation, and adaptive post-processing and feedback learning—remain the same.

The server applies the above-described methods not only to textual guidance but also to the management of communication logs and aggregate analytics. By storing structured information and emotion information in unified data structures, the server enables efficient querying and batch processing. The server can generate statistical reports about the frequency of certain types of expressions, the occurrence of flagged harassment risks, and the distribution of feedback ratings. These reports can be used to adjust system-level models and thresholds. Because the underlying data structures are normalized and indexed, the server executes such queries with reduced compute load and latency compared to repeated re-parsing of raw text logs.

The system thereby provides a technical solution that improves computer functionality in several ways. The structured representation of natural language text reduces repeated parsing workloads, the context-rich prompt sentence increases the efficiency and stability of generative AI calls, the integrated post-processing pipeline enforces compliance in a single pass rather than in multiple independent stages, and the adaptive feedback mechanism refines system behavior without manual reprogramming. These operations are implemented through specific data structures, neural network architectures, and control rules executed by the server, resulting in improved processing speed, reduced error rates in wording suggestions, and more reliable control over communication content delivered to terminals in real-world environments.

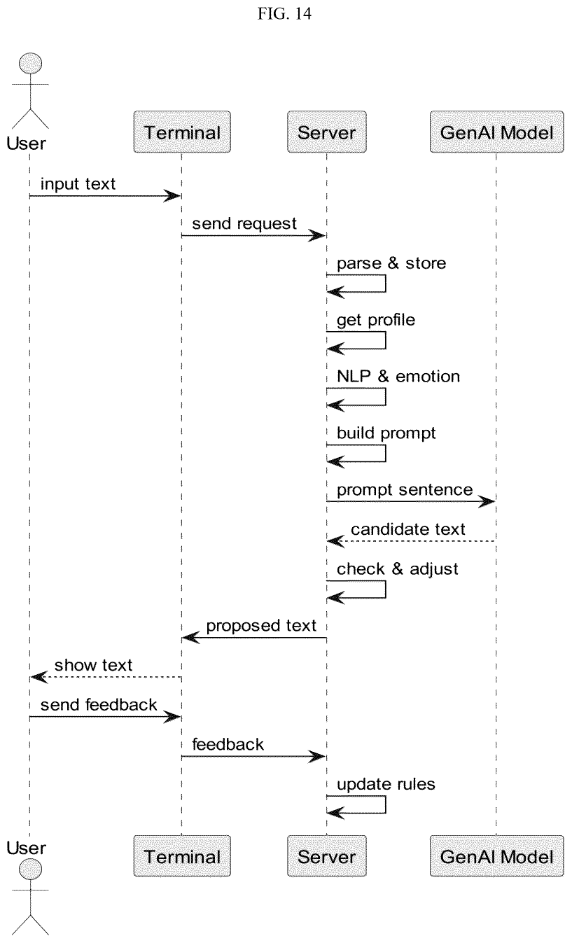

The following describes the processing flow using FIG. 14.

### Step 1

User operates the user terminal to input natural language text.

User enters, via a keyboard or touch interface, an instruction or feedback sentence (for example, “The assembly of part A is delayed. Please generate a respectful instruction.”) together with a selection of the target subordinate.

Input: raw natural language text, subordinate identifier, user identifier.

Output: structured request object held in the terminal's memory, containing the text string and identifiers.

Terminal validates text length and character encoding, creates a request object with fields (user_id, subordinate_id, raw_text, timestamp), and prepares this object for transmission.

### Step 2

Terminal transmits the request object to the server.

Terminal converts the request object into a message for network transmission and sends it through a communication interface using a protocol such as HTTPS.

Input: structured request object from Step 1.

Output: HTTP request containing a serialized representation (for example, JSON) of the raw_text and identifiers, delivered to the server.

Terminal sets headers, adds an authentication token, and initiates an asynchronous network call.

### Step 3

Server receives and records the input data.

Server accepts the HTTP request, parses the body, and validates required fields (raw_text, subordinate_id, user_id).

Input: HTTP request containing raw_text and identifiers.

Output: database record in a communication table and an in-memory representation for further processing.

Server executes an insertion operation into a relational database, storing the raw_text, user_id, subordinate_id, and timestamp, and returns an internal communication_id for use in subsequent steps.

### Step 4

Server retrieves subordinate profile information.

Server queries a profile table using the subordinate identifier to obtain attribute fields such as age group, gender, role, and experience.

Input: subordinate_id from Step 3.

Output: profile information object associated with the subordinate.

Server executes a database SELECT operation, converts the retrieved row into a typed structure, and caches this structure in memory alongside the communication record.

### Step 5

Server performs language analysis on the user's text.

Server applies a language analysis program to the raw_text, including tokenization, part-of-speech tagging, and syntactic parsing.

Input: raw_text from the database record.

Output: structured information including task content, situation, emotional expression, and type of intent.

Server runs parsing algorithms that iterate over the token sequence, identify verb phrases and noun phrases, map specific patterns (for example, “assembly of part A is delayed”) to fields (task_content=“assembly of part A”, situation=“delay”), and classify the sentence type as instruction, feedback, or other using a trained classifier.

### Step 6

Server estimates user emotion from the text.

Server applies an emotion analysis program, implemented as a neural network classifier, to the raw_text and optionally to additional features derived from the parsed structure.

Input: raw_text and, optionally, features such as sentence embedding from Step 5.

Output: emotion information including emotion label (for example, concern, frustration) and confidence values.

Server converts the text into numerical vectors (for example, token embeddings), feeds them through a multi-layer network, computes an output probability distribution over emotion classes, and selects the class with highest probability as the emotion label.

### Step 7

Server combines structured information and profile information.

Server associates the structured information with the profile information to form unified context data.

Input: structured information from Step 5 and profile information from Step 4.

Output: context object containing fields for task_content, situation, type_of_intent, and subordinate attributes.

Server merges these data into a single composite structure, storing it in memory and updating the communication record with references to this composite structure.

### Step 8

Server constructs a prompt sentence for the generative AI model.

Server uses a template generator to convert the context object and the emotion information into a textual control sequence.

Input: context object from Step 7 and emotion information from Step 6.

Output: prompt sentence string containing explicit instructions for the generative AI model.

Server inserts values into template slots such as “Work content: [task_content]”, “Situation: [situation]”, and “Subordinate profile: [age_group, role]”, and appends a description of required style and constraints.

For example, Server generates a prompt sentence:

“Work content: assembly of part A.

Situation: delay.

Subordinate profile: age group 20s, male, factory worker, 3 years of experience.

Manager emotion: concern and slight frustration.

Task: Generate a clear, respectful instruction sentence from the manager to the subordinate that explains the delay, asks for efficiency improvement, and avoids any harassing or offensive tone.”

### Step 9

Server invokes the generative AI model using the prompt sentence.

Server encodes the prompt sentence into tokens and forwards them to the generative AI model running locally or via an external service.

Input: prompt sentence from Step 8.

Output: candidate expression string generated by the generative AI model.

Server performs tokenization, passes the token sequence through the model's layers, obtains predicted next tokens until a termination condition is met, and decodes the token sequence back to characters to form the candidate expression.

### Step 10

Server performs inappropriate expression detection on the candidate expression.

Server executes a detection module that evaluates the candidate expression against rules and classifiers.

Input: candidate expression from Step 9.

Output: detection result indicating whether the candidate expression contains potentially harassing or prohibited content.

Server scans for disallowed terms using pattern matching, computes a feature vector of the candidate expression, applies a classifier to score harassment likelihood, and sets a flag in the communication record if the score exceeds a threshold.

### Step 11

Server applies guideline conformity determination and format adjustment.

Server compares the candidate expression with stored guideline rules and adjusts the expression's structure and formatting.

Input: candidate expression and detection result from Step 10, guideline configuration data.

Output: adjusted expression that conforms to guidelines and normalized formatting, referred to as the proposed expression.

Server checks whether required components (e.g., statement of reason, supportive closing) are present, inserts or rewrites segments if missing, splits long sentences, adjusts punctuation, and capitalizes according to display standards.

### Step 12

Server finalizes and stores the proposed expression.

Server designates the adjusted expression as the proposed expression and updates persistent storage.

Input: adjusted expression from Step 11.

Output: database update reflecting the proposed expression associated with the communication record.

Server writes the proposed expression to a field in the communication table, logs the generation event, and marks the processing status as completed.

### Step 13

Server prepares a response for the user terminal.

Server compiles a response message containing the proposed expression and metadata such as emotion label and model identifier.

Input: proposed expression and associated metadata from Step 12.

Output: response object ready for network transmission.

Server serializes the data into a response structure, sets HTTP status information, and enqueues the message in the network stack.

### Step 14

Terminal receives and displays the proposed expression.

Terminal accepts the server's response, decodes it, and renders the proposed expression on a display component.

Input: HTTP response from Step 13 containing the proposed expression.

Output: visual representation of the proposed expression on the user terminal's screen.

Terminal parses the response body, extracts the text, updates the user interface to replace any loading indicators, and shows the expression in a text area where the user can read or edit it.

### Step 15

User reviews, optionally edits, and applies the proposed expression.

User reads the proposed expression and may modify wording to suit a specific situation, then uses the expression to communicate with the subordinate.

Input: displayed proposed expression from Step 14.

Output: final instruction or feedback text used by the user in actual communication.

User may copy the text into another application, speak it verbally, or send it electronically, thereby applying the system's output in a real-world context.

### Step 16

User or subordinate provides feedback on the proposed expression.

User or subordinate enters a reaction text or a rating through the user terminal or subordinate terminal.

Input: final instruction or feedback experienced by the subordinate, and a user-entered evaluation or comment.

Output: feedback object containing reaction text or rating.

Terminal collects the feedback, packages it with identifiers (communication_id, subordinate_id), and sends it back to the server over the network.

### Step 17

Server stores and analyzes feedback data.

Server receives the feedback object, associates it with the corresponding communication record, and evaluates its content.

Input: feedback object from Step 16.

Output: updated feedback table entries and analysis results (for example, satisfaction level or detected emotion).

Server stores the feedback in persistent storage, runs an emotion analysis program on the reaction text to infer the subordinate's emotional response, and updates aggregated metrics such as average satisfaction per expression style and attribute group.

### Step 18

Server updates prompt generation rules and style mappings.

Server adjusts internal configuration governing how future prompt sentences and expression styles are constructed.

Input: analysis results and aggregated metrics from Step 17.

Output: modified rule sets for prompt generation, attribute-to-style mappings, and thresholds for post-processing.

Server computes statistics (for example, feedback average per style category), applies update algorithms to mapping tables (e.g., increasing preference for more supportive wording for certain attribute profiles), and writes new parameter values into configuration storage to influence subsequent executions of Steps 8 through 11.

### Step 19

Server optionally generates audio data and controls worker terminal playback.

Server, when audio output is requested, uses a speech synthesis program to transform the proposed expression into audio data and transmits it to a worker terminal.

Input: proposed expression from Step 12 and a flag indicating audio output requirement.

Output: audio data streamed or delivered to a worker terminal for playback.

Server sends the text to a text-to-speech engine, receives encoded audio, and forwards the audio via a communication interface; the worker terminal decodes the audio and drives a speaker so that the worker hears the instruction.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

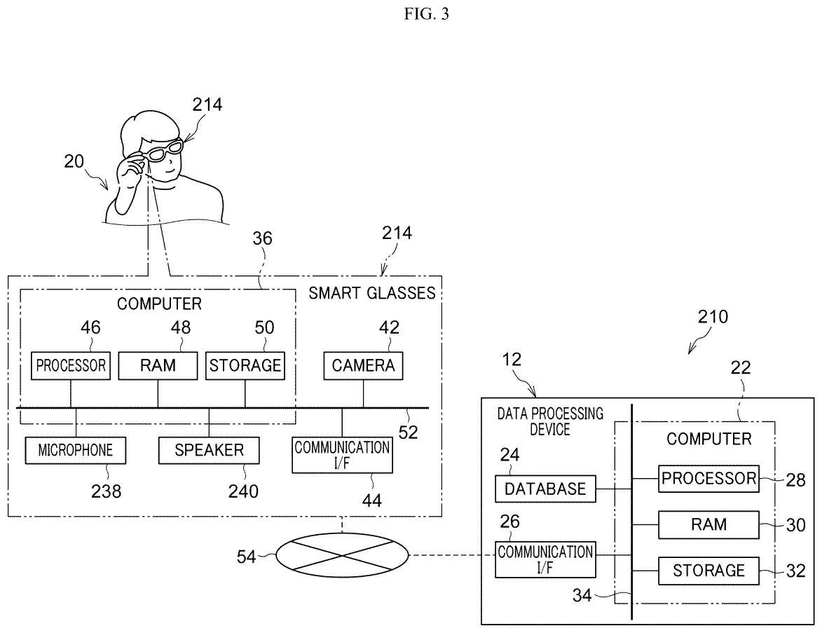

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

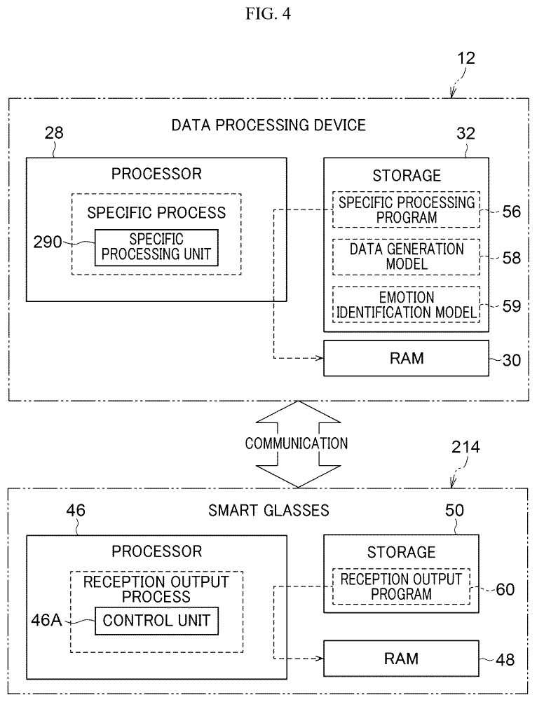

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

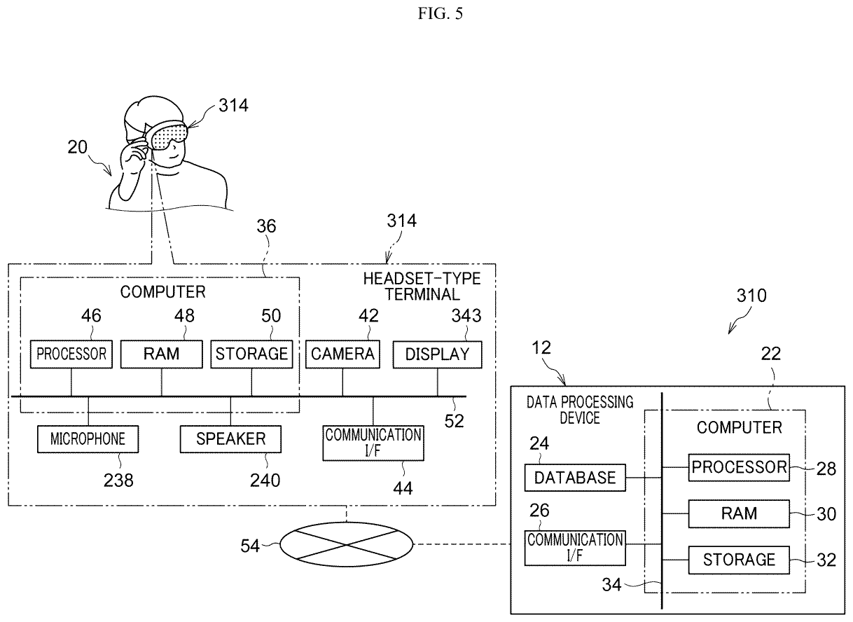

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

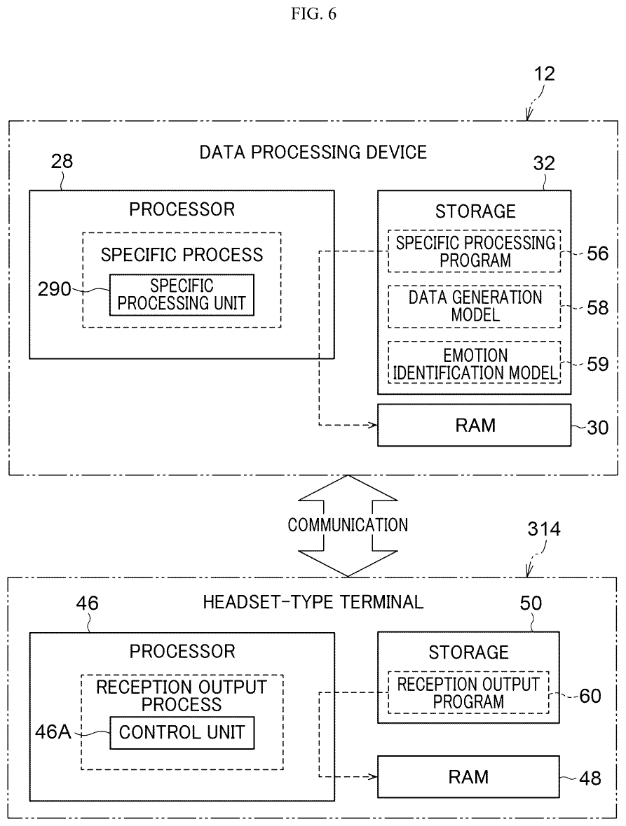

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

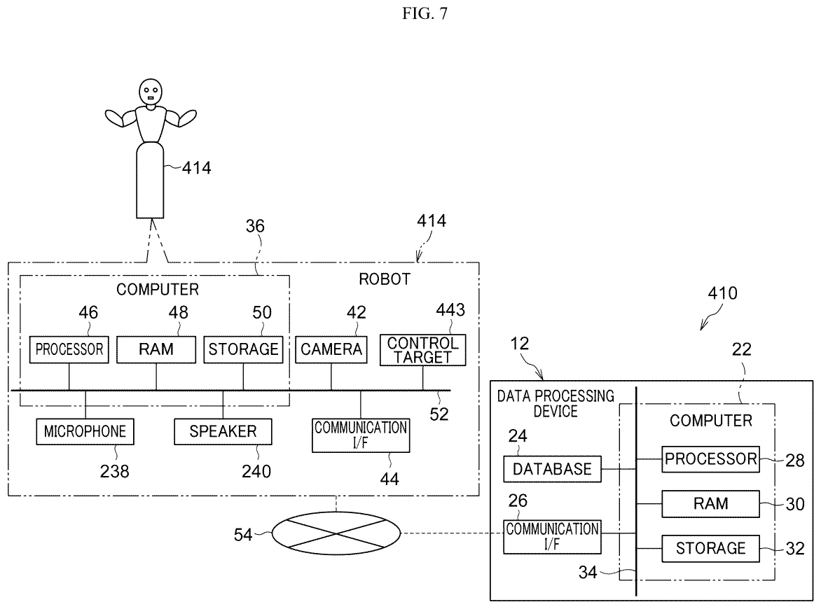

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

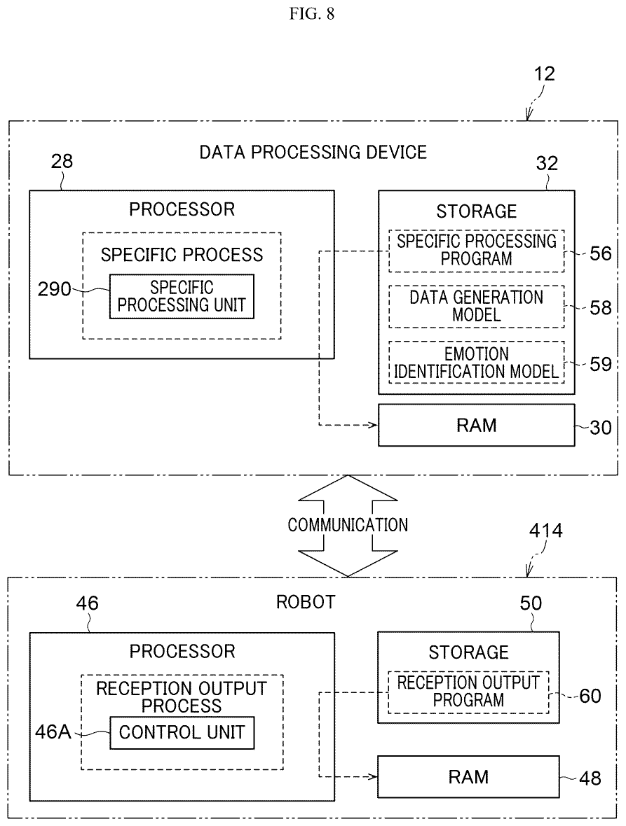

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

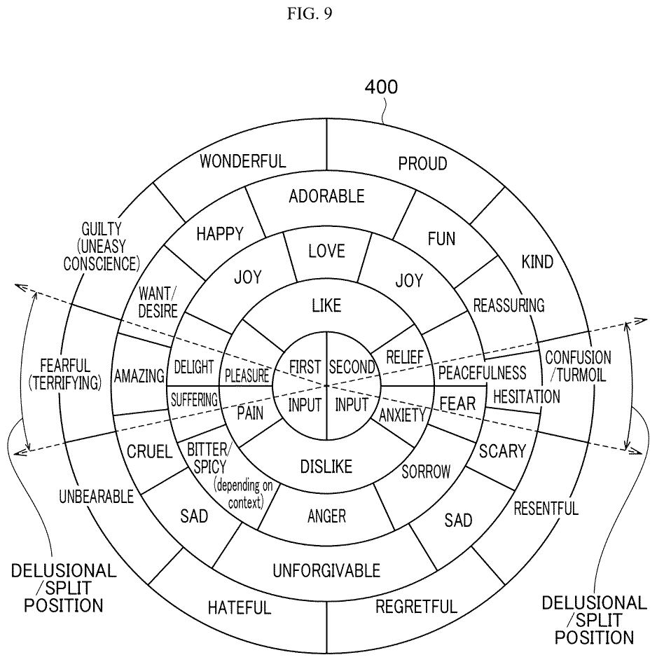

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

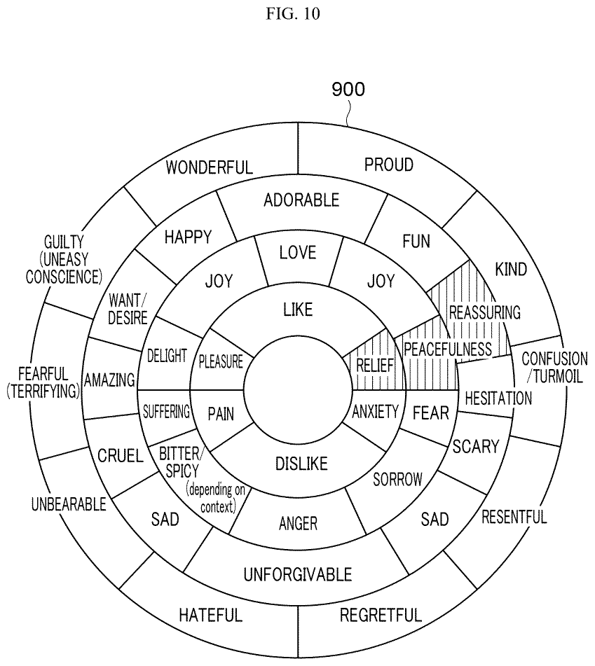

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire attribute information of a subordinate and identify the subordinate based on management information including the attribute information,
generate a prompt sentence to be input to a generative AI model, the prompt sentence being generated based on character information relating to an instruction or feedback input by a manager via a terminal, the attribute information of the identified subordinate, and conditions relating to a type of communication and a tone of wording,
input the generated prompt sentence to the generative AI model and cause the generative AI model to generate a linguistic expression corresponding to the attribute information of the subordinate and the conditions,
execute a content evaluation process on the generated linguistic expression to detect an inappropriate expression or an expression corresponding to harassment, and correct or regenerate the linguistic expression based on a result of the detection, transmit the corrected or regenerated linguistic expression to the terminal and present the corrected or regenerated linguistic expression on the terminal as a proposed message that is viewable and editable by the manager, and
store, as record information, a final message after editing by the manager, original input character information corresponding to the final message, the attribute information of the subordinate, and a proposal history by the generative AI model in association with each other, and update at least one of generation conditions of the prompt sentence or a guideline based on the record information.

### Supplementary 2

The system according to supplementary 1,
wherein the processor is configured to
evaluate the linguistic expression generated by the generative AI model by applying criteria relating to honorific expressions, a level of politeness, a level of casualness, and clarity of an instruction content, and automatically adjust at least one of a tone or a representation format of the linguistic expression based on a result of the evaluation.

### Supplementary 3

The system according to supplementary 1,
wherein the processor is configured to
automatically generate guideline information relating to concretization of terminology, reduction of ambiguous expressions, and avoidance of prohibited expressions, based on the instruction or feedback input by the manager via the terminal, the attribute information of the subordinate, and the linguistic expression generated by the generative AI model, and present the guideline information on the terminal together with the linguistic expression.

### Application Example 1

### Supplementary 1

A system comprising a processor,
wherein the processor is configured to
acquire attribute information of a worker from an information storage device based on identification information of the worker and analyze the attribute information of the worker, analyze text data of a work instruction input from the worker by using a natural language processing language model and generate structured data including action information and target information of the work instruction,
generate a prompt sentence for input to a generative AI model based on the attribute information of the worker and the structured data, input the prompt sentence to the generative AI model, and generate a feedback sentence for the worker, and transmit the feedback sentence for the worker to an output control device and cause a machine to output sound or text as a response to the worker.

### Supplementary 2

The system according to supplementary 1,
wherein the processor is configured to
perform style control in which a writing style and a politeness level of the feedback sentence are changed according to age information and gender information included in the attribute information of the worker during generation of the prompt sentence.

### Supplementary 3

The system according to supplementary 1,
wherein the processor is configured to
store the prompt sentence and the feedback sentence for the worker as log information and perform evaluation or analysis regarding improvement of communication between the worker and the machine based on the log information.

### Example 2

### Supplementary 1

A system comprising a processor,
wherein the processor is configured to
acquire, from an information terminal connected to an information processing apparatus, information regarding an instruction or feedback to a managed person, store the information in a data storage device, and analyze case information and event information included in the information,
generate, on the basis of the analyzed case information and event information, a prompt sentence to be input to a generative AI model, the prompt sentence including constraint conditions relating to prevention of harassment and ease of understanding by a recipient, input the generated prompt sentence to the generative AI model, cause the generative AI model to generate an optimized instruction sentence or feedback sentence corresponding to the case information and the event information, and acquire a generation result,
execute an inappropriate-expression detection process and a readability evaluation process on the generation result, and, when an inappropriate expression is detected or when the readability does not satisfy a predetermined criterion, generate an additional prompt sentence for correcting the generation result and re-input the additional prompt sentence to the generative AI model so as to automatically regenerate or correct the generation result, and output, as a final generation result, the optimized instruction sentence or feedback sentence to the information terminal, cause the optimized instruction sentence or feedback sentence to be displayed on a display screen of the information terminal, receive an edit operation or an approval operation by a user, and store an approved sentence in association with related information in the data storage device.

### Supplementary 2

The system according to supplementary 1,
wherein the processor is configured to
analyze past instruction or feedback history information stored in the data storage device, and update, in a learning manner, a set of prohibited expressions or a determination criterion used in the inappropriate-expression detection process, thereby continuously improving harassment prevention performance in communication between a manager and the managed person.

### Supplementary 3

The system according to supplementary 1,
wherein the processor is configured to
generate guideline information, based on the case information, the event information, and the generation result, the guideline information explicitly indicating a target to be achieved, a deadline, specific work contents, and support contents so that the managed person can appropriately understand contents of an instruction, and transmit the guideline information to the information terminal to be presented.

### Application Example 2

### Supplementary 1

A system comprising a processor,
wherein the processor is configured to
acquire, from a user terminal, natural language text data relating to an instruction or feedback for a subordinate and attribute information of the subordinate as input data, perform language analysis processing on the natural language text data to extract structured information including at least task content, situation, emotional expression, and type of intent, and associate the attribute information of the subordinate with the structured information and store the associated information as profile information,
generate a prompt sentence that explicitly defines conditions for generating an expression to be provided to the subordinate by using the structured information, the profile information, and emotion information of a user estimated from the natural language text data by an emotion analysis device or an emotion analysis program, input the prompt sentence into a generative AI model, and cause the generative AI model to generate a candidate expression reflecting at least the subordinate's attributes, a work situation, and an emotional state of the user,
perform post-processing including at least inappropriate expression detection processing, guideline conformity determination processing, and format adjustment processing on the candidate expression output from the generative AI model, adjust the candidate expression from viewpoints of preventing harassment, improving ease of understanding, and improving acceptance, determine a final proposed expression, and output the proposed expression to the user terminal,
accumulate, as feedback data, reaction text, evaluation information, or emotion information regarding the proposed expression acquired from the user terminal or a subordinate terminal, and update at least a generation rule for the prompt sentence, a correspondence relationship between the attribute information and an expression style, and a determination condition used in the post-processing in accordance with the feedback data so as to adaptively improve content and tone of the proposed expression subsequently generated, and
when generation of audio data corresponding to the proposed expression is required, input the proposed expression into a speech synthesis device or a speech synthesis program to generate the audio data and output the audio data to a worker terminal.

### Supplementary 2

The system according to supplementary 1,
wherein the processor is configured to acquire, as monitoring target data, the natural language text data and the candidate expression or the proposed expression output from the generative AI model, perform the inappropriate expression detection processing on the monitoring target data to detect an expression that may correspond to harassment or may deteriorate a work environment, and, in accordance with a detection result, control modification or suppression of output of the candidate expression or the proposed expression.

### Supplementary 3

The system according to supplementary 1,
wherein the processor is configured to generate instruction clarification guide information including at least explanation elements, important points, recommended expression examples, and prohibited expression examples so that the subordinate can appropriately understand contents of an instruction from a manager, based on the structured information and the profile information, present the instruction clarification guide information to the user terminal, and reflect the instruction clarification guide information in the prompt sentence so as to improve clarity and ease of understanding of the candidate expression generated by the generative AI model.

What is claimed is:

1. A system comprising:
circuitry configured to:
receive, via a communication interface coupled to a packet-switched network, character information representing an instruction or feedback input by a first user via a terminal device;
acquire attribute data associated with a second user and generate a structured prompt sentence based on the character information, the attribute data, and conditions relating to a communication type and a wording tone;
execute inference processing using a generative neural network model with the structured prompt sentence as input to generate a linguistic expression corresponding to the attribute data and the conditions;
execute a content evaluation process on the generated linguistic expression to detect an expression satisfying a prohibited expression criterion, and correct or regenerate the linguistic expression based on a detection result; and
transmit the corrected or regenerated linguistic expression to the terminal device as a proposed message, and store, as record information, a final message, original input character information, the attribute data, and a proposal history of the generative neural network model in association with each other, and update generation conditions of the structured prompt sentence based on the record information.

2. The system according to claim 1, wherein the circuitry is configured to identify the second user from management information comprising the attribute data based on identification information received from the terminal device.

3. The system according to claim 2, wherein the circuitry is configured to include, in the structured prompt sentence, at least the attribute data, a classified communication type, and a tone parameter derived from the conditions.

4. The system according to claim 3, wherein the circuitry is configured to evaluate the generated linguistic expression by applying criteria relating to a politeness level, a casualness level, and clarity of instruction content, and automatically adjust at least one of a tone parameter or a representation format of the linguistic expression based on an evaluation result.

5. The system according to claim 4, wherein the circuitry is configured to adjust the representation format of the linguistic expression in accordance with at least one attribute parameter included in the attribute data, including at least one of an age parameter and a position parameter of the second user.

6. The system according to claim 1, wherein the circuitry is configured to monitor text data exchanged between the first user and the second user and apply the content evaluation process to detect expressions satisfying the prohibited expression criterion in the exchanged text data.

7. The system according to claim 6, wherein the circuitry is configured to generate an alert signal when an expression satisfying the prohibited expression criterion is detected in the monitored text data, and transmit the alert signal to the terminal device.

8. The system according to claim 1, wherein the circuitry is configured to analyze the character information using a natural language processing model to generate structured data comprising action information and target information, and include the structured data in the structured prompt sentence.

9. The system according to claim 8, wherein the circuitry is configured to estimate an affective state of the first user based on the character information using an affective recognition algorithm, and adjust a wording tone parameter in the structured prompt sentence in accordance with the estimated affective state.

10. The system according to claim 9, wherein the circuitry is configured to modify the proposed message toward a more neutral tone parameter when the estimated affective state indicates elevated stress, and toward a more directive tone parameter when the estimated affective state indicates high confidence.

11. The system according to claim 1, wherein the circuitry is configured to automatically generate guideline data relating to at least one of concretization of terminology, reduction of ambiguous expressions, and avoidance of prohibited expressions, and transmit the guideline data to the terminal device together with the proposed message.

12. The system according to claim 11, wherein the circuitry is configured to generate the guideline data based on the character information, the attribute data of the second user, and the linguistic expression generated by the generative neural network model.

13. The system according to claim 1, wherein the circuitry is configured to update the generation conditions of the structured prompt sentence by computing updated condition parameters based on the record information, including at least one of frequency-of-use metrics, edit-distance metrics between proposed messages and final messages, and attribute correlation metrics.

14. The system according to claim 13, wherein the circuitry is configured to re-rank generation condition parameters by applying the updated condition parameters, and use the re-ranked generation condition parameters in subsequent prompt sentence construction.

15. The system according to claim 1, wherein the circuitry is configured to generate feedback output data based on the attribute data of the second user and the structured data, and transmit the feedback output data to an output control device for presentation to the second user.

16. The system according to claim 15, wherein the circuitry is configured to perform style control in which at least one of a writing style parameter and a politeness level parameter of the feedback output data is adjusted based on the attribute data.

17. The system according to claim 1, wherein the circuitry is configured to store the structured prompt sentence and the generated linguistic expression as log information, and perform analysis on the log information to compute communication improvement metrics for the first user and the second user.

18. A system comprising:
circuitry configured to:
receive, via a communication interface coupled to a packet-switched network, character information from a terminal device operated by a first user;
acquire attribute data associated with a second user, analyze the character information using a natural language processing model to generate structured data comprising action information and target information, and construct a structured prompt sentence incorporating the attribute data, the structured data, and constraint conditions relating to a communication type and a wording tone;
execute inference processing using a generative neural network model with the structured prompt sentence as input to generate a linguistic expression;
apply criteria relating to a politeness level, a casualness level, and instruction clarity to evaluate the linguistic expression, detect expressions satisfying a prohibited expression criterion in the linguistic expression, and correct or regenerate the linguistic expression based on a detection result; and
transmit the corrected or regenerated linguistic expression to the terminal device as a proposed message, generate guideline data relating to terminology concretization and prohibited expression avoidance, and update generation conditions of the structured prompt sentence based on stored record information comprising a proposal history.

19. The system according to claim 18, wherein the circuitry is configured to estimate an affective state of the first user from the character information using an affective recognition algorithm, and adjust a tone parameter in the structured prompt sentence in accordance with the estimated affective state.

20. A method comprising:
receiving, via a communication interface coupled to a packet-switched network, character information representing an instruction or feedback input by a first user via a terminal device;
acquiring attribute data associated with a second user and generating a structured prompt sentence based on the character information, the attribute data, and conditions relating to a communication type and a wording tone;
executing inference processing using a generative neural network model with the structured prompt sentence as input to generate a linguistic expression corresponding to the attribute data and the conditions;
executing a content evaluation process on the generated linguistic expression to detect an expression satisfying a prohibited expression criterion, and correcting or regenerating the linguistic expression based on a detection result; and
transmitting the corrected or regenerated linguistic expression to the terminal device as a proposed message, and storing, as record information, a final message, original input character information, the attribute data, and a proposal history of the generative neural network model in association with each other, and updating generation conditions of the structured prompt sentence based on the record information.
